(19) United States
(12) Patent Application Publication
(10) Pub. No.: US 2016/0275439 A1
(43) Pub. Date: Sep. 22, 2016

(54) WEB AND MOBILE BASED SCHEDULER AND METHODS FOR IDENTIFYING EMPLOYMENT NETWORKING OPPORTUNITIES UTILIZING GEOLOCATION

(71) Applicant: Roger Avats, Elwood (AU)

(72) Inventor: Roger Avats, Elwood (AU)

(21) Appl. No.: 14/964,578

(22) Filed: Dec. 10, 2015

Related U.S. Application Data
(63) Continuation-in-part of application No. 14/661,266, filed on Mar. 18, 2015.
Application No. 14/661,266 is a continuation-in-part of application No. 14/821,587, filed on Aug. 7, 2015.

(51) Int. Cl. G06Q 10/06; G06Q 50/00; G06Q 10/10

(52) U.S. Cl. CPC G06Q 10/063118; G06Q 10/1053; G06Q 50/01

(57) ABSTRACT

The present invention is directed, in part, to a system and methods for human resources management and efficient, online and mobile guidance on assisting job seekers in locating and securing job opportunities. More specifically, the present invention relates to a system and methods for performing substitute fulfillment, including identifying acceptable substitute employees/professionals, job opportunity review, real time employee availability, skill set review for employers/clients, appointment scheduling and establishing network connections amongst employers/clients and employees/professionals for both current and future job opportunities. Even more specifically, the present invention relates to building experience hours through successive work experience, establishing network connections and securing employment through historical connections among subscriber users and in optimizing staffing to accommodate for peak and non-peak business hours. Further, the present invention provides methods and a system for optimizing scheduling for available employment shifts through geolocation and internet sources.

### FIELD OF THE INVENTION

The present application claims priority to U.S. Non Provisional application Ser. No. 14/611,266, filed Feb. 1, 2015, U.S. Non Provisional application Ser. No. 14/821,587, filed Aug. 7, 2015, the contents of which are hereby incorporated in their entirety.

The present invention relates generally to a system and methods for human resources management and efficient, online and mobile guidance on assisting job seeker in locating and securing temporary or permanent job opportunities. More specifically, the present invention relates to a web and mobile based system and scheduler and methods of use for performing for example, substitute fulfillment, including identifying acceptable substitute employees (permanent or temporary), job opportunity review, employee availability, skill set review for employers, appointment scheduling and establishing network connections amongst employers and employees for both current and future job opportunities that arise in which qualified employees are paired with appropriate employers whom are seeking to fill either temporary or permanent positions. Even more specifically, the present invention relates to a scheduler and methods that employs online and mobile device capability in which subscriber users can create, publish and edit their respective availability for accepting new employment opportunities. Such availability can be created and published for viewing by prospective employers whom can retain the services of posting employees. Employee subscriber users have the option of posting current availability, posting their lack of availability for accepting new employment and for posting a time period in which employers can reserve the employee's time to occupy an available job position at a future time. Employee subscriber users can also post their availability to accept new employment only after a certain predetermined desired rate of pay is offered by an employer. The system pairs available employees whom possess pertinent skill sets with employers seeking to fill current or future works shifts with employees within a desirable geographic location (i.e., situated in close proximity to the employment shift) possessing such skill sets. The invention further relates to an app-based network of employers, skilled workers, professionals and potential clients finding local business opportunities and staffing solutions in real time

### BACKGROUND OF THE INVENTION

Traditionally, staffing companies and online resources such as LinkedIn® and other websites match millions of people to millions of available job opportunities. By latest estimates, there is an average of 5 million people per day are employed by staffing companies. The prior art is replete with methods and systems used to match available and skilled employees to open job positions requiring specific qualifications and availabilities (i.e., temporary versus permanent, current or future) however, methods and systems currently known are similarly replete with shortcomings.

In that regard, social media and other online resources as well as mobile technology has provided another avenue by which employers and qualified employees can connect. Computer networks have given rise to a wide variety of online marketplaces providing employers and employees alike with the ability to buy and sell goods, exchange marketplace ideas and to generally connect with other individuals such as family and friends.

Likewise, one service area in particular that has been impacted signficantly by the growth of the online and mobile technology marketing industry is the job search services sector. The internet and mobile technology industries have changed the approach many people take in performing a search for a new job. Websites such as Monster.com® and LinkedIn® are immensely popular and proven modes of matching qualified job seekers to available positions in the marketplace. However, even these popular websites lack an inherent ability to efficiently match the right job candidate with the appropriate employment opportunity at the right time. The present invention goes beyond that which is known in the prior art by allowing network connections to connect and know instantly what their respective availabilities are and allows subscriber users of the invention the ability to find a group of individuals who possess the desired skill set sought.

A commonly used approach to matching job candiates to open positions involves the identification of a candidate's skills so as to match the candidate with an open position requiring those skills. Although this has proven an effective way of locating employees possessing particular job skills, there are seemingly an endless myriad of other characteristics and factors that are not considered when using traditional candidate search methods. For example, current or future availability of the job candidate and their real time location is rarely considered by traditional candidate search criteria. Also, whether a qualified candidate is seeking short term, long term, permanent or temporary work is rarely factored into current methods of identifying appropriate candidates to fill available job vacancies or shifts. Of practical concern is the often times need of an employer or client to retain the services of an employee or other professionals who are within a desirable geographic location, with the employee or professional able to take on employment almost at a moment's notice such as occurs during the course of a work day when an employee calls in sick or a client cancels an appointment during a particular busy day.

Another common approach to matching job candidates to open positions involves the use of directed questions to evaluate the job candidate. The results of the evaluation are used to compare the candidate to the open positions and identify a match, if any. As before, such methods still do not factor in other pertinent criteria related to matching qualified candidates to available job opportunities. Even in instances in which a small pool of candidates is ascertained for in-person interview, the lack of experience of many employers in conducting effective job interviews becomes a factor in what candidate is selected for the available position. As is often the case, job interviews by an employer is often merely “fit into” the supervisor's already busy work day and as a result, the interview process itself may fail to identify an appropriate candidate for the position. With the present system app claimed, a subscriber user can upload their current employer information (or provide a link to a site that holds their current information), number of recommendations, current shift that an employee or professional is working and for whom the shift is being worked and a list of a subscriber user's network connections so that an Employer or Client subscriber user can see if a particular subscriber user is currently connected via the system app to other employees.

Relating to the marketplace of temporary employment, the method of performing Substitute Fulfillment in matching qualified candidates with appropriate employment opportunities has been one of particular interest in the online and mobile device industries. Substitute Fulfillment is generally understood as a process of locating a replacement employee to fill a temporary employee absence in an organization. The method however has been found to be an unreliable, labor-intensive process. In any organization, the absence of an employee critical to on-going operations can have a perceptible negative impact in the particular business affected. Other factors that may be important in filling a temporary position within an organization include fulfillment of pending deadlines and ensuring that workflow and productivity is maintained throughout the absence of the permanent employee as well as maintaining and/or enhancing customer service.

Further relating to the needs of the job market is the need of employers to accurately determine the experience level of a pool of prospective employees at a glance. Accordingly, one particular aspect of the present invention is to accurately measure the “Experience Hours” of employee subscriber users so that employer subscriber users are able to make an educated decision on what candidate best fits their current employment needs. So called “experience hours” are the number of hours tracked by the system application and methods pertaining to a particular employee. A further embodiment of the present invention is the ability of the system application and methods to select a preferred employee candidate for a particular employment position posted by a particular employer subscriber user. The “historical connection” aspect include a process in which the system application automatically recognizes a historical connection between a particular employee and a particular employer and during instances in which the particular employer posts a new position, the particular employee will be notified of the employment opportunity regardless of whether the employee conducts an employment search. Thirdly, “employment geolocation” is yet another embodiment of the present invention. In particular employment geolocation employs a mobile device search engine such as Google® for example, and determines the peak times in which a particular employer will require more employees to fill work shifts. For example, the system application and methods thereof capture peak volume and rush time information that is available on mobile device accessible web sites, and allows employer subscriber users to create their employee schedules to ensure that they are properly staffed during times in which patronage is at a peak. By way of scenario, a mobile device web site gathers peak patronage times for a particular restaurant such as for example, from between 6:30 pm to 8:45 pm on Saturday nights. The system application and methods thereof notifies the employer of times that the employer must staff extra employees in order to properly manage a dinner time rush. Accordingly, the employer will staff the peak rush shifts so that sufficient labor is available to handle the peak volume times. Likewise, the system application and methods provide times in which patronage is low thus, allowing the employer to staff a minimal number of employees and preventing overstaffing a particular day or evening shift. In order to ensure that the urgency and importance of filling both permanent as well as temporary employment opportunities and matching those opportunities to qualified employees are addressed, a novel system and methods are warranted. As the world has grown smaller due to the advent of mobile phone and technology, newer methods of connecting qualified employees with available job opportunities are needed more than ever. Accordingly, shortcomings in the field of employee and employment opportunity matching, remain. Further, existing solutions fail to address particular deficiencies that confront businesses and consumers seeking alternatives to the existing art and a solution to advancing efficient and accurate job matching for both employees and employers remain elusive. The present invention addresses these shortcomings.

### SUMMARY OF THE INVENTION

The present invention is directed to an improved method and a system that efficiently and accurately tracks the number of hours and experience an employee/professional subscriber user possesses in his particular work history in relation to a particular employer or employers. “Experience Hours” are tracked for a particular employee, tallied and stored for review by future employers seeking qualified employees. For example, Employee Smith has worked for Employer A as a wait person for a total of 250 hours which has been logged and tracked by the system application. Meanwhile Employee Jones has worked for Employer A for a total of 400 hours which has also been logged and tracked by the system application. In a circumstance in which Employer A is later (i.e., at a time when neither Employee Smith or Employee Jones currently work for Employer A) seeking qualified candidates to fill an available shift, Employer A conducts an employee search on the system application for qualified candidates to fill the available position. As part of the candidate results list, the system application and methods thereof will notify Employer A regarding the difference in qualifications between the two employees (i.e., Employee Jones and Employee Smith) whose names both turned up in the results list of the search. The system application notifies the relative experience level of the employees listed in the search list and thus, gives the employer the opportunity to make a decision between the two employees for a work shift that is available according to their respective experience levels.

To gather, tally and log the number of experience hours a particular employee has, the system application app is activated at the start of a shift, at a particular business and the system application and methods, using geolocation information, gathers the start time of the employee's shift, the end time of the employee's shift, the business address and the date on which the experience hours are worked. The system application, using geolocation information on the employee's mobile device app, automatically logs the number of hours worked and stores them in the employee's experience hours tally for that particular employer. Successive shifts build on the experience hours tally and communicates the experience hours to the employer as well as other employer subscriber users seeking and searching for qualified employees for available shifts. Experience hours build over the course of the employee's work history and is included in the employee's online resume of qualifications which are accessible to all employer subscriber user's seeking qualified employees. Accordingly, the experience hours element of the invention provides verifiable work history information for a particular employee.

The experience hours also apply to the client and professional subscriber user relationship. For example, in the case of personal trainer Smith whom is employed by Employer X, wherein personal trainer Smith trains Client Jones for a training session, personal trainer Smith also gathers and generates experience hours for the time in which he trains Client Jones and also gathers experience hours as an employee of Employer X as a personal trainer. Accordingly, other potential clients can view the number of hours that personal trainer Smith has serviced other similar clients seeking training services.

The system application and methods thereof further provides employer subscriber users with the option of staffing available work shifts based on a historical or previous experience with a sought after employee. By way of scenario, Employee Smith previously worked with Employer A for 2 years. Employee Jones has never worked for Employer A but is qualified to work for Employer A. During a search of employees to fill an employment shift, Employer A generates a results list of qualified candidates which includes both Employee Jones and Employee Smith. The system application notifies Employer A that Employee Smith has 2 years previous experience with Employer A and so Employee Smith is highlighted and prioritized as a more viable candidate as compared to Employee Jones. The Historical Connection therefore notifies employers of those employee candidates with whom they have previous experience so that such employers can staff their available work shifts with individuals possessing past experience with that employer. The system application highlights and notifies employers of those employees whose names are included in a search results list whom have worked for the employer in the past. In so doing, employers can schedule those employees with whom they have knowledge and previous experience and they can further prioritize hiring those individuals over other employees for whom the employer has no previous experience or knowledge. The historical connection element of the system application also notifies employers with the names of employees with whom they have previous experience and whom they can connect with on the system application, for those employee not already connected to the employers.

Thirdly, the system application and methods thereof provide staffing geolocation capability that allows an employer to optimize his staffing needs for peak business times and days. The system application gathers peak and non-peak business time information from internet sources and presents the information to employers who are staffing an employment shift. In particular, during a search of a business on a mobile device utilizing Google®, the search results provide “Popular Times” information which provides a business's peak business times and days and which the system application gathers and stores. When a manager assesses his staffing needs, the system application overlays the peak and non-peak information gathered from the “popular times” associated with the manager's business and overlays the peak and non-peak time graphic with the manager's work schedule.

By overlaying the peak and non-peak time and day information onto the manager's shift schedule, the manager is able to determine his staffing needs during the business peak and non-peak times and days. For example, when the Google® “popular times” search results for the manager's business indicate slow business at 9 am, Tuesdays, the manager will staff minimally for the time period. Contrary, if the “popular time” information gathered indicates peak business at noon on Tuesday, the manager can see the need visually and staff a sufficient number of shift workers to handle the peak business time.

For example Employer A, using the mobile device app of the system application, searches his own business using the system application. The system application gathers peak as well as non-peak time and day information for the business from internet source “Popular times” and displays the graphical information to Employer A via interface on the system application app. Employer A utilizes the information to add extra staff during peak business times and days and to decrease staff count during non-peak business times and days. Staffing geolocation therefore provides the employer with a graphical interface that allows optimization of staffing levels in accordance with the peaks and non-peak times and days of a particular business.

The invention further relates to providing job seekers with a mobile device-based and implemented application as well as an online method of presenting their qualifications and skill sets to potential employers on a global scale. The scheduler of the invention allows employee/professional subscriber users to enter, publish and edit their times of availability to accept new employment, enter their times of unavailability to accept new employment, to enter times of availability that can be reserved by employer/client subscriber users for job opportunities that are available at some future time point. It further offers employee/professional subscriber users the ability to accept employment they would otherwise not accept except when the employment is offered above a predetermined desired rate of pay. Likewise, the mobile application (i.e., “app”) and online interface allows employers/client subscriber users to communicate to qualified employees/professional subscriber users on a global scale regarding job opportunities that are either temporary or permanent in nature and which may be currently available or which may be available in the near future. The system allows employer/client subscriber users the ability to provide the global community with highly specific details and requirements related to the positions or services required and employment opportunities they are looking to fill.

The present invention is further directed to an improved method and system of matching qualified and available employees with job positions or services that are currently available or positions or services that will shortly become available to such employees or professionals. The system and method further allow the job seekers as well as employers and clients to establish networking contacts by which current or future employment opportunities can be discussed and positions and jobs filled. The invention allows for efficient and accurate matching of employees/professionals and employers/clients in a convenient and mobile application “app” which can also be accessed via the Internet.

As described, the system and methods herein allow for a novel manner in which employers/clients can fill current and future available positions and required services with employees/professionals possessing qualifications tailor fit for the positions/services in which they seek to fill. Included and within the scope of the mobile-device implemented system application described herein is also an improved system and method of identifying and locating replacement workers to fill a temporary employee absence in an organization, also known as a substitute fulfillment system. In order to optimize the value and utility of the claimed system app, it is imperative that network connections be established so that employee/employer and client/professional working relationships can be established. In other words, the more network connections a subscriber user has associated with their system app account, the easier and more efficiently job opportunity relationships, and therefore job opportunities, will arise. Likewise the system and methods described herein allow employers/clients to network and “connect” with potential employees/professionals, on a global scale, and to match their own qualifications to only those employers/clients that require such qualification thus, negating the wasteful practice of resume mass mailing and interviews by supervisors unaccustomed to conducting effective interviews that will produce the best candidate for their position.

Foremost, the present invention is directed to an employment scheduler and methods of use which allow subscriber users to identify employment opportunities on a web-based or mobile-based medium for which they qualify, to apply for such positions, and to post their availabilities for accepting new job opportunities as they arise on a temporary or permanent basis, as well as on a salaried or hourly shift type basis. The scheduler described herein allows for creating, publishing and editing various modes of availability for accepting new employment including for example, current availability so that employer/client subscriber users can schedule an available employee/professional subscriber for a job opportunity immediately. It also includes the ability for an employee/professional to post his unavailability so that prospective employers seeking to fill immediate shifts can see that a particular employee/professional is not available to schedule for work. In such a mode, the employer can still push the job opportunity to the unavailable employee. Thirdly, an employee/professional subscriber user can create, publish and edit a time period in which employers can reserve (i.e., reserved availability) the employee's time in order to staff and schedule for a job opportunity at some future time point.

Finally, employee/professional subscriber users can create, publish and edit their availability for accepting current or future employment above a certain predetermined rate of pay (i.e., Peak Demand Availability or Variable Availability). By way of example, Employee A is not willing to accept an hourly shift at $15.00 per hour, but will accept such an offer if an employer offers $20.00 per hour, thus giving employers the ability to hire highly desired and skilled employees. The scheduler of the invention can be created in two- or three-dimensions. In two-dimensional scheduling, an employer/client subscriber user schedules a particular employee/professional subscriber user for a particular open job opportunity and the work relation exists between the two. In three-dimensional scheduling, Employer/client subscriber users can schedule an employee/professional subscriber user for a service position. The employee/subscriber user, in such a case, can then hire out his services to a third party to provide those services. The scheduling relation extends to all three individuals.

### BRIEF DESCRIPTION OF THE DRAWINGS

FIGS. 1A and 1B depict an electronic page on a mobile device wherein a subscriber user is able to enter experience and job skills to their subscriber account. The page also depicts buttons wherein a subscriber can push a button in order to begin searching to invite possible network connections or search for subscribers who can fill a shift or job opportunity (i.e., employers, employees, professionals and clients).

FIGS. 2A and 2B illustrate the electronic page on a mobile device wherein a subscriber user enters skills and qualifications to their subscriber account with such information also including hourly pay rate and pertinent skills.

FIGS. 3A and 3B illustrate an additional electronic page on a mobile device related to the “skills” portion described in FIG. 2. More specifically, the illustration provides an electronic page wherein the subscriber user can view their skills, recommendations and enter additional job history and previous work history.

FIGS. 4A and 4B illustrate an electronic page on a mobile device which shows a subscriber user profile electronic page in which a subscriber user can edit or enter additional information regarding the user's background, experience and qualifications. Also depicted, specifically in 4B is the subscriber user's availability for taking available job opportunities.

FIGS. 5A and 5B illustrate an electronic page on a mobile device wherein a subscriber user can add the user's current and future availability for taking on new job opportunities including the ability to add preferred hourly wage and job type sought.

FIGS. 6A and 6B illustrates an electronic page on a mobile device wherein a subscriber user can edit the user's availability and further, the user is able to forward the updated availability to employer/client contacts within the user's network of connections.

FIGS. 7A and 7B illustrate an electronic page of the invention on a mobile device wherein a subscriber user can forward or “push” the subscriber user's availability to other subscriber users that may have an interest in employing the subscriber user.

FIGS. 8A and 8B illustrate an electronic page of the invention on a mobile device display wherein a subscriber user can edit and add search and filtering criteria when either searching for job opportunities or in searching for qualified candidates to fill available job positions or shifts. Specifically, the page displays the ability to filter search criteria and limit such criteria to remain for example, within a certain mileage.

FIGS. 9A and 9B depict an electronic page of the invention on a mobile device display wherein an employer subscriber user adds a new job opportunity that has become available with the user's company. The page allows job details to be added to screen and provides a button by which employee/professional subscriber users can apply.

FIGS. 10A and 10B illustrate an electronic page of the invention on a mobile device display wherein the dates and times for a job opportunity are displayed and viewable by subscriber users.

FIGS. 11A and 11B illustrate an electronic page of the invention on a mobile device display that communicates to an employer/client subscriber user that one more employee/professional subscriber users has applied for the job position posted including for example the name and date and time of the position applied for.

FIGS. 12A and 12B illustrate an electronic page of the invention on a mobile device display wherein a subscriber user can create a corporate profile including for example, the name of the business, the industry type as well as size of the business.

FIG. 13 illustrates a preferred embodiment of the hardware and software backend of the invention as it relates to the software and “app”. As shown, the illustration illustrates the relationship between the software app and the Amazon Web Services environment that will host the app.

FIG. 14 illustrates an embodiment of the scheduler of the invention. In particular employee/professional subscriber users input availability information, including time such subscriber users are available for reserved time. The Figure illustrates a day view interface in which employee/professional subscriber users input availability, non-availability, reserved and variable available information.

FIG. 15 illustrates an embodiment of the scheduler of the invention. In particular, a “week view” availability is depicted wherein an employee/professional subscriber user's availability is displayed on either the web based or mobile based system platform. The scheduler depicts, for example, a subscriber user's committed employment shifts. Subscriber users can be displayed as either temporary or permanent.

FIGS. 16A, B, C and D illustrate the “reserved” availability scheduler for an employee/professional subscriber user. In particular, an employee/professional subscriber user inputs his availability information into the system platform interface which displays days of the week along with hours. Employer/client subscriber users reserve available time by engaging the system platform interface and reserving a desired and time.

FIGS. 17A, B, C and D illustrate the scheduler wherein an employee/professional subscriber user is added to a particular day and time. A publish button allows availability information to be disseminated to all network connections once availability information is inputted. The scheduler provides geographical location of the job opportunity and the title of the position sought.

FIGS. 18A, B, C and D illustrate the scheduler wherein an “alias” is utilized to inter availability information for employment. By way of example, alias “MJ” is placed in a particular row within the interface which is not linked to availability information. Selecting a particular employee/professional subscriber user from a dialog box replaces the alias and the selected employee/professional replaces the alias and is linked to availability information.

FIGS. 19A, B, C and D illustrate the scheduler wherein a work shift is created. In particular, a subscriber user creates a shift pertaining to an employee/professional subscriber user's availability by reserving the employee/professional user's available time. The user creates the shift by selecting within an employee's “reserved” time period.

FIG. 20 illustrates an aspect of the system platform wherein job opportunities are displayed and wherein employee/professional subscriber user's can view, select and apply for particular positions of interest.

FIG. 21 illustrates an aspect of the system platform. In particular, a specific job description is displayed when a subscriber user selects and clicks on a particular available job opportunity, including for example, pay rate, location and contact information.

FIG. 22 illustrates an aspect of the system platform. A specific job description is displayed as well as a listing of current applicants for the job position including a summary description of the applicant's professional background.

FIGS. 23A, B, C and D depict the system platform and the posting of an available employment opportunity or work shift. Work dates, job title, rate of pay, geographical location as well as other pertinent job information is displayed.

FIGS. 24A, B, C and D depict the system platform and display of a draft job posting being prepared by an employer/client subscriber user with the job posting depicted shown prior to publication to other subscriber users. The draft job posting includes information such as job title, rate of pay, geographical location, work dates and qualifications among other information.

FIGS. 25A and 25B depict the Scheduler wherein a job creator invites particular individual employees for posted positions. In particular, an employer subscriber user selects “invite workers” and selects individuals whom possess desirable professional skills and experience for the position. The employer has the option of selecting an employee and inviting those individuals to apply for the job opportunity.

### DETAILED DESCRIPTION OF THE INVENTION

The present invention provides a system, system app and methods that efficiently and accurately match qualified employee/professional subscriber users with suitable employer/client subscriber users so that job opportunities (i.e., temporary or permanent, current or future) can be filled with appropriately qualified and experienced individuals. The mobile device implemented job placement and recruitment system and methods allows subscriber users to establish account “network connections” with other subscriber users whom may be employers/clients or employees/professionals. The system and methods allows subscriber users to be either an employee/professional subscriber user (job seeker) or an employer/client subscriber user (job provider or a user searching for a service) depending on the needs and provisions of the subscriber user. Subscriber users can also be both an employee subscriber user as well as a employer subscriber user. Likewise, subscriber users can be designated as a client subscriber user, a professional subscriber user or both. Therefore, the present invention is an app-based network of employers, skilled workers, professionals and potential clients finding local business opportunities and staffing solutions in real time.

For instance, an employer subscriber user can post an available position on the employer subscriber user's account profile but the employer subscriber user can also be an employee subscriber user if that user chooses to apply for a position posted on the app. In other words, a subscriber user can be either an employer subscriber user, an employee subscriber user, professional subscriber user, client subscriber user or they may be all four. Included and within the scope of the mobile-device implemented system application described herein, is also an improved system and method of identifying and locating replacement workers to fill a temporary employee absence in an organization, also known in the field of professional staffing as a substitute fulfillment system.

From a practical perspective, the service sector subscriber users have multiple jobs and there is a need to optimize the effective utilization of skills, location and availability using real time push notification and geomapping to establish reliable estimated time of arrival (ETA) for employees/professional to job sites where they are needed. The social networking application or system app, solves the “just in time” need of filling work shifts or opportunities by connecting employees and professionals to all their employers and clients respectively, so that there is instant visibility of available individuals by their skills, time of day, day of week, hourly rate, review and ETA information.

With the claimed social networking application or system app, a user can upload their current employer/client information (or provide a link to a site that holds their current information), past employer/client information, number of recommendations, current shift or opportunities the employee/professional is working and for whom the employee/professional is working those shifts or jobs for, and the employee's/professionals list of connections so that an employer/client can see if an employee or professional subscriber user are currently connected to other employees/professional for the business.

With the claimed social networking system, the more people that are connected the greater the opportunity is for users to begin quickly and efficiently filling available job positions or job shifts on a real time basis. Unlike LinkedIn® and Monster®, users of the social networking system gain real time monetary benefit through their connections and gaining more work through real time availability updates. Accordingly, the more connections, the more opportunity to secure additional work resulting in subscriber users having a tangible reason (monetary benefit) to actively invite more and more network connections.

Experience Hours

The present invention is more particularly directed to an improved method and a system that efficiently and accurately tracks the number of hours and experience an employee/professional subscriber user possesses in his particular work history in relation to a particular employer or employers. “Experience Hours” are generated and tracked for a particular employee, tallied and stored for review by future employers seeking qualified employees. For example, Employee Smith has worked for Employer A as a wait person for a total of 250 hours which has been logged and tracked by the system application. Meanwhile Employee Jones has worked for Employer A for a total of 400 hours which has also been logged and tracked by the system application. In a circumstance in which Employer A is later (i.e., at a time when neither Employee Smith or Employee Jones currently work for Employer A) seeking qualified candidates to fill an available shift, Employer A conducts an employee search on the system application for qualified candidates to fill the available position. As part of the candidate results list, the system application and methods thereof will notify Employer A regarding the difference in qualifications between the two employees (i.e., Employee Jones and Employee Smith) whose names both turned up in the results list of the search. The system application notifies the relative experience level of the employees listed in the search list and thus, gives the employer the opportunity to make a decision between the two employees for a work shift that is available according to their respective experience levels.

To gather, tally and log the number of experience hours a particular employee has, the system application app, including a computer processor and database, is activated at the start of a shift, at a particular business and the system application and methods, using an internet source and geolocation information, gathers the start time of the employee's shift, the end time of the employee's shift, the business address and the date on which the experience hours are worked. The system application, using geolocation information on the employee's mobile device app, automatically logs the number of hours worked (i.e., experience hours) and stores them in the employee's experience hours tally for that particular employer. Successive shifts build on the experience hours tally and communicates the experience hours to the employer as well as other employer subscriber users seeking and searching for qualified employees for available shifts. Experience hours build over the course of the employee's work history and is included in the employee's online resume of qualifications which are accessible to all employer subscriber user's seeking qualified employees. Accordingly, the experience hours element of the invention provides verifiable work history information for a particular employee.

The system application and the experience hours elements of the invention, based on geolocation tracking in a mobile device, tracks the time, date and particular business worked by the employee subscriber user, and also displays an employee's work schedule in the system application for the work conducted. The time gathered and stored constitute “experience hours”. For the shift, the employee subscriber user will have different amounts of experience hours at one business, versus another business at which the employee has previously worked. In such a scenario, an employer subscriber can choose to hire an employee subscriber user based on an employee subscriber user's particular experience hours. Experience hours also provide assistance in obtaining future employment based on the number and quality of experience hours a particular employee subscriber possesses.

The experience hours also apply to the client and professional subscriber user relationship. For example, in the case of personal trainer Smith whom is employed by Employer X, wherein personal trainer Smith trains Client Jones for a training session, personal trainer Smith also gathers and generates experience hours for the time in which he trains Client Jones and also gathers experience hours as an employee of Employer X as a personal trainer. Accordingly, other potential clients can view the number of hours that personal trainer Smith has serviced other similar clients seeking training services.

In particular, the professional and client subscriber user relationship, or 3-D relationship is created when a professional subscriber user whom provides a service (i.e., personal training, plumber, etc.) is retained by a client such as an individual requiring the professional subscriber user's services. During the hours retained by the client, the professional subscriber user accumulates and gathers experience hours for every hour of work for services conducted on behalf of the client. The hours are gathered and stored by the system application computer processor and database so that the information is displayed and viewable in the user's member profile and wherein it is displayed during client searches for services such as those provided by the professional subscriber user.

In the instance in which the professional is hired by an employer subscriber user to provide such services to third party clients, experience hours are also accumulated by the professional subscriber user for hours in which the professional subscriber user provides services on behalf of the employer. In this scenario, the professional subscriber user accumulates experience hours in a 3-D relationship, namely, 1) experience hours for services provided on behalf of an employer subscriber user and 2) experience hour accumulated for the services provided to the client.

Historical Connections

The system application and methods thereof further provides employer subscriber users with the option of staffing available work shifts based on a historical connection or previous experience with a sought after employee. By way of scenario, Employee Smith previously worked with Employer A for 2 years. Employee Jones has never worked for Employer A but is qualified to work for Employer A. During a search of employees to fill an employment shift, Employer A generates a results list of qualified candidates which includes both Employee Jones and Employee Smith.

The system application notifies Employer A that Employee Smith has 2 years previous experience with Employer A and so Employee Smith is highlighted as a viable candidate for the position. The Historical Connection therefore notifies employers of those employee candidates with whom they have previous experience, even if those employees are not network connections of the employer, so that such employers can staff their available work shifts with individuals possessing past experience with that employer as opposed to qualified employees with no previous experience. The system application notifies employers of those employees whose names are included in a search results list whom have worked for the employer in the past. In so doing, employers can schedule those employees with whom they have knowledge and previous experience and they can further prioritize hiring those individuals over other employees for whom the employer has no previous experience or knowledge. The historical connection element of the system application also notifies employers with the names of employees with whom they have previous experience and whom they can connect with on the system application, for those employees not already connected to the employers.

The historical connection element of the invention also prompts the employee subscriber user whom has previously worked for the particular business/employer and notifies them of the open positions at the business so that they can apply for the positions directly again, even in the event the employee is not a network connection of the employer/business. Both the employer and employee only need be members of the system application with a profile so that the system application is able to recognize the historical experience of the employee as well as the current shift needs of the employer based on the employer's schedule, which is created and stored on the system application.

The system application recognizes, based on the historical connection elements of the invention, that a particular business has shift opportunities for a particular position (i.e., bartender). The system will also recognize an employee subscriber user whom has previously worked at the particular business but no longer does so and whom has a member profile on the system application. Further, the system application recognizes that the employee subscriber user whom has previously worked at the particular business, is not a network connection of the particular business on the system application and will invite the employee to establish a network connection with employers with a historical connection to the employee.

The system application recognizes that the unconnected employee subscriber user has availability in her schedule (i.e., scheduler) and also recognizes that the employee subscriber user is within the geographical location of the available position. In so recognizing, the system prompts the employee subscriber user that the position is available. Likewise, the system application automatically prompts the employer subscriber user and inquires whether the employer would like to connect with the employee subscriber user. The employer can choose to connect or not to connect via the system application. And the employee subscriber user has the option of applying to the open shift position.

Geolocation Scheduling

Thirdly, the system application and methods thereof provide staffing geolocation capability that allows an employer to optimize his staffing needs for peak business times and days. The system application gathers peak and non-peak business time information from internet sources, such as from Google® Popular Times, and presents the information on the system application to employers who are staffing an employment shift. In particular, during a search of a particular business on the system application, the system application will gather peak and non-peak business days and times from data providers such as for example Google® “Popular Times”, information which the system application gathers and stores. When a manager/employer subscriber user assesses his staffing needs, the system application overlays the peak and non-peak information gathered from the “Popular Times” data associated with the manager's business and overlays the peak and non-peak time graphic with the manager's current weekly or daily work schedule to provide an illustrative view of the employer's staffing needs for the period of time selected.

By overlaying the peak and non-peak time and day information onto the manager's shift schedule, the manager is able to determine his staffing needs during the business peak and non-peak times and days. For example, when system application accesses the the Google® “Popular times” data and generates the search results for the manager's business which indicates slow business at 9 am, Tuesdays, the manager will staff minimally for the time period. Contrary, if the system application information gathered indicates peak business at noon on Tuesday, the manager can see the need visually and staff a sufficient number of shift workers to handle that particular peak business time.

By way of further example Employer A, using the mobile device app of the system application, searches his own business using the system application. The system application gathers peak as well as non-peak time and day information for the business from internet sources such as for example Google® “Popular times” and displays the graphical information to Employer A via interface on the system application app. Employer A utilizes the information to add extra staff during peak business times and days and to decrease staff count during non-peak business times and days by assessing the overlay of the peak/non peak business time with the employer's scheduler. Staffing geolocation therefore provides the employer with a graphical interface that allows optimization of staffing levels in accordance with the peaks and non-peak times and days of a particular business.

To create an overlay of the employer's current staffing needs with the peak and non-peak times of the business, an employer subscriber user opens the system application, and searches his business on the system application. Typically the result provides a pull down menu that displays the Google® “Popular times graphic that demonstrates the peak and non-peak times and days for the particular business. The system application captures this information and overlays that information over the employer's current schedule of shifts and the system application illustrates the overlay in so that it is easily visible to the employer and manager of the employer. So the geolocation staff optimization gives an employer the ability to assess how well the employer is staffed for that particular day and time and allows the employer to staff accordingly via the scheduler of the invention.

The invention as a whole can be summarized without limitation by the following description. In a preferred embodiment, the system and methods are accessed via a mobile device application (i.e., “app”) or through a website interface. In this embodiment, the app is downloaded to a mobile device. Thereafter, the user is able to create a user account wherein the user enters details including but not limited to name, mailing address and phone information, email address and qualifications including any and all information typically found in an individual's resume. In this preferred embodiment, individual users entering prior work history and experience are deemed an employee/professional subscriber user.

Included in the preferred embodiment, a subscriber user can create an account profile wherein the user enters details including but not limited to corporate name, business size, location and contact information. The subscriber user in this instance can also post available job opportunities for which employee/professional subscribers can view and apply to such positions or opportunity. Subscriber users whom post corporate information and available job opportunities are deemed employer or client subscriber users however, within the scope of the invention is the allowance of an employer/client subscriber user to also act as an employee/professional subscriber user should the employer/client subscriber user ever choose to apply for available position and/or opportunity that are posted on the interface app.

As described herein the mobile “app” and/or website interface allows an employee/professional subscriber user to view available job positions and opportunities in real time and further allows them to apply for only those positions and/or opportunities to which their background and qualifications best fit. Also as described herein, the mobile app and/or website interface of the invention allows an employer/client subscriber user to post positions and/or opportunities that are either currently available or positions and/or opportunities that will be available in the future, providing potential employee/professional subscriber users with detailed information relating to the position including but not limited to time and date required for the position and/or opportunities, location and place of employment, qualifications required and other employer/client contact information necessary including hourly rate.

It is therefore, a primary object of the present invention to provide a system and methods, employing a mobile device app and/or website interface, that efficiently and accurately match suitably qualified employee/professional subscriber users to available job positions and/or opportunities and employers/clients seeking such employees/professional for either temporary or permanent work, or for current or future work. In addition to the specific definitions provided below, each of the terms employed in the claims are understood to have a similar meaning and understanding as the terms are generally known and accepted to hold in the art.

The term “subscriber user” as used herein refers to an individual whom has created a user account and profile on the app and/or website interface, who is seeking current or future employment or alternatively, an individual whom is seeking a qualified job candidate that can fill an available position and/or opportunity.

The term “employee subscriber user” as used herein refers to an individual whom has created a user account on the app and/or website of the invention whom posts details regarding their professional background, work history and experience so that the information is available to potential employers. The term also refers to, among other things, an individual whom searches the app's database for available positions that are posted by employers on the app and/or website and to those individuals whom apply for such positions by forwarding their real time availability, recommendations, hourly rate and qualifications to employers in need of such employees.

The term “employer subscriber user” and the like, as used herein refers to an individual whom has created a user account on the app and/or website of the invention whom posts the need of an employee possessing particular skills and experience for a position available currently or in the future at the employer subscriber user's business. The term also refers, among other things, to an individual whom searches the app's database for qualified applicants whom possess skills and experience necessary in order to fill the employer subscriber user's needs.

The term “professional subscriber user” and the like, as used herein, refers to an individual whom has created a user account on the system app/or website of the invention whom is seeking to provide services for pay to other subscriber users on the system app. The individual as designed hereto will possess skills that can be marketed in a posting produced by the professional subscriber user on the system app describing among other things, real time availability, geographic location of the professional, hourly rate, recommendations and professional skills.

The term “client subscriber user”, “client user” and the like, refers to an individual whom has created a user account on the system app/or website of the invention whom is seeking the services of another subscriber user's professional skills. For example, a client subscriber user will advertise their need of a specific and particular skill set and professional background by posting such need on the system app with requirements including for example, skill set, geographic location, date/time required, requested pay rate to perform the needed job duties and list of qualifications sought.

The term “available”, “availability” and the like, as used herein, as it relates to employee subscriber users refer to the employee subscriber user's ability to accept employment either presently or in the future. The term “available”, “availability” and the like as used herein, as it relates to employer subscriber users refers to the employer subscriber user's ability to provide a job opportunity either presently or in the future.

The term “app”, “application” and the like, as used herein refers to a self-contained program or piece of software designed to fulfill a particular purpose. As described herein, an application is a software program or piece of software that can be downloaded by a user to a mobile device.

The term “situated” and the like as used herein, refers to the presence and availability of a subscriber user within a specified geographical location so that the geographical location in which the subscriber user is located fulfills the job requirements specified in one or more job opportunities posted on the system application. For example, used herein, a job posting can require that a prospective employee subscriber must reside within a 10-mile radius from the job site. In the instance in which an employee subscriber user resides within a 10-mile radius of the job site, that employee subscriber user is appropriate situated to fulfill the requirements of the job description and requirements. Further to the term, as envisioned herein, situated can also refer to an amount of time required for an employee to get to a job or employment opportunity. Such as for example, an employer subscriber user can select only those employee subscriber users whom are within a 20 minute commute from the place of business.

The term “geolocation” as used herein generally refers to a process of reporting one's location to other user subscribers who are members of the system application. Geolocation and methods of using geolocation will report one's location to other users including but not limited to estimated time of arrival (ETA). For example, Employee A is x number of minutes from an employer's place of business. The term also refers to the system application tracking the time an employee subscriber begins work for a particular available employment shift and when the shift ends, by activating and deactivating the system application respectively. Geolocation also notifies network subscriber users of one's real-world location. The term also refers to the system application notifying a subscriber user that there are x number of employers near the subscriber user's current location. The term also refers to the system application notifying a subscriber users of the number of available employment shift opportunities exist near the user's current location. The term also refers to the system application communicating the professional skills and background of a particular employee or employer subscriber user to other network subscriber users whom are within a given geographic vicinity. For example, the geolocation element will communicate that Employee A possessing skills as a dog trainer, is within 5 miles of businesses with an interest in hiring Employee A to fill an available employment shift. Therefore, the businesses can hire Employee A and the employee will be readily available and in close proximity to fill the available position.

The term “Geomapping”, “Geo mapping” or the like as used herein refers to identification of the real-world geographic location of subscriber users of the system application so that it can assess location (street address) of subscriber users relative to one other for the purpose of determining distance, travel time, and estimate time of arrival to meet between users. The terms “geomapping” and “geo mapping” will be understood to encompass subset elements of the geolocation of a subscriber user.

The term “connection”, “network connection” and the like as used herein refer to the establishment of a network relationship between two or more individuals for the purpose of employing use of the invention. For example, a “connection” or “network connection” is established when one subscriber user employs use of the invention to reach out to other subscriber users in order to form a relationship using the aspects of the invention for the purpose of conducting current or future business with one another. The term “connection”, “network connection” as used herein, will also be connoted as a noun in which a “connection” or “network connection” will be referred to as a subscriber user whom has established a network or “app” relationship with another subscriber using the aspects of the invention that are attributed to establishing such relationships. Likewise, the term “connection”, “network connection” and the like as used herein is intended to occupy the same meaning and understanding as is known in the current and prior art. A “connection” or “network connection” and like terms, can refer to employee subscriber users as well as employer subscriber users, professional subscriber users, as well as client subscriber users.

The term “invite”, “invitation” and the like as used herein refer to the extension of the opportunity to establish a connection from one subscriber user to another. For example, as described herein, one subscriber user can, by employing the aspects of the invention app, forward an invitation to another subscriber user with the opportunity to form a relationship on an app or website account for the purpose of conducting current or future business or for the purpose of advancing job opportunities. The term “push invite” as used herein refers to one subscriber user extending an offer of a network relationship to another.

The term “active job”, “active job opportunity” and the like as used herein refer to the existence of a job opportunity to which an employee subscriber can pursue via use of the app invention. The “active job”, “active job opportunity” is intended to refer to job opportunities that are currently available and also those to which will be available in the future. For example, an “active job” can refer to a job opportunity that isn't scheduled to begin until a future, definitive date.

The term “directly hired”, “directly”, “hired directly” or the like as used herein, refers to the hiring of an employee or professional subscriber user by an employer or client subscriber user respectively for services. For example, the employer or client subscriber user will be in a position of paying the employee or professional subscriber user respectively, directly with no third party job placement entity. In such, a direct employee/employer or professional/client business relationship, the employee or professional will be paid directly by the employer or client subscriber user.

The term “members”, “member subscriber” or the like as used herein, refers to an individual whom has fulfilled the requirements of subscription and has been given the right to use the system application of the invention. For example, a member of the system network application will generally provide among other things, name, user name, a password, a subscription fee and other contact information prior to being given the ability to use the system network application.

The term “potential employee subscriber user”, “potential professional subscriber user” and the like as used herein refers generally to an employee or professional subscriber user whom possesses professional qualifications and job skills that match the requirements outlined in a job posting created by an employer/client subscriber user. The term also includes an employee or professional subscriber user that is able to conduct work toward the one or more job opportunities within the day and time schedule requirements and further, includes an employee subscriber user that is located, geographically, within a desirable vicinity to the one or more job opportunities as outlined in the job requirement descriptions posted by the employer subscriber user. Likewise, a “potential employer subscriber user”, “potential client subscriber user” or the like, as used herein refers to a client or employer subscriber user that has posted one or more job opportunities on the system application wherein the required qualifications of the posted position match the background and professional qualifications of one or more employee or professional subscriber users.

The term “recommendations” and the like as used herein refers to the ability of subscriber users to prepare a critique of another subscriber user's work performance upon the completion of one or more jobs/shifts by an employee/professional subscriber user. For example, an employer/client subscriber user can write a recommendation related to the work performance of an employee/professional subscriber user whom the employer/client subscriber user hired for one or more job/shift opportunities, once the job(s)/shift(s) have been completed, with the recommendation being postable on the employee subscriber user's profile account.

The term “push notification”, and the like as used herein generally relates to either employer/client subscriber users, employee/client subscriber users or to both and generally refers to the system application providing a means to a subscriber user to either actively or automatically sending job and professional background information via the system application. Specifically, as it relates to employee/professional subscriber users, such users can actively (i.e., manually) push their professional qualifications and interest to an employer/client subscriber user for a particular job/shift that the employer/client subscriber user has posted on the system application.

Similarly, “push notification” is accomplished automatically wherein the system application employs software that automatically sends out, on behalf of employee/professional subscriber users, the professional background and job experience of employee/professional subscriber users, to open job/shift opportunities that have been posted by employer/client subscriber users. For example, an employee/professional subscriber user can push their account information to directly either to an employer/client subscriber user's account or to one or more job opportunities posted on the system application. Likewise, employer/client subscriber users can push their account information and/or one or more job opportunities directly to employee/professional subscriber user's accounts whether those employee/professional subscriber users are within the employer/client subscriber users network or not.

Likewise, an employer/client subscriber user can actively push one or more job/shift opportunities to prospective employee/professional subscriber users to notify the employee/professional subscriber users of the existence of the job opportunities. Similarly, “push notification” is accomplished automatically, on behalf of employee/client subscriber users, wherein the system application employs software that automatically sends out open job/shift opportunities to prospective employee/professional subscriber users that the system application determines to be a match for the one or more job opportunities.

The term “results list” and the like as referred to herein, generally relates to the ability of the system application to allow a subscriber user (i.e., employer/client and/or employee/professional) to conduct searches. For example, as it relates to an employer/client subscriber user, such users can enter search criteria into the system application software, conduct the desired search for potential employee/professional subscriber users whom possess job qualifications that match job opportunities that the employer/client seek to fill. Upon conducting such a search, a list of potential employee/professional subscriber users that match job requirements is generated by the system application. The list generated is generally referred to as a “results list” or an employer/client results list.

As the term relates to searches conducted by employee/professional subscriber users, the system application allows such users to search for one or more job opportunities that are currently available on the system software which possess job qualification requirements that match the employee/professional subscriber user's experience and job skills. Upon conducting the search, a list of available job opportunities will be generated by the system application. This list, as it relates to employee/professional subscriber users is generally referred to as a “results list” or an employee/professional results list.

The term “job opportunities” and the like as used herein, generally refers to both permanent and temporary work. The term also describes and is intended to include work that is merely part of an available shift, a whole shift, one week or longer, whether on a permanent or temporary type basis. The job opportunities of the invention generally relate to direct hiring (i.e., either temporary or permanent) of the employee/professional subscriber user by the employer/client subscriber user. In other words, there are no third parties involved in the retention of an employee/professional subscriber user to perform job opportunities. As envisioned herein, employer/client subscriber user hire employee/professionals directly.

The term “real time push notification” and the like as used herein refers to immediate notification by an employer/client subscriber user, employee/professional subscriber user or to both by either active (i.e., manual) or automatic notification of a potential match between an employee/professional subscriber user's background qualifications and the requirements of one or more job opportunities posted by an employer/client subscriber user. An example of a real time push notification can occur wherein an employee/client subscriber user is no longer able to work for which the employee was previously hired. In real time push notification the employee/client in such a scenario is able to immediately update his lack of availability for the job so that the employer/professional subscriber can set out to immediately locate a suitable alternative. In such a notification, in this scenario, the employee/client subscriber user can thereafter immediately update their availability for other new job opportunities.

The term “declines” as used herein generally refers to the instance in which an employee/client subscriber user has reviewed the job qualifications and professional experience associated with an employee/professional subscriber user that has applied to one or more job opportunities posted by the employee/client subscriber user on the system application and has decided not to retain the services of the employee/professional subscriber user for the one or more job opportunities. In the instance in which the employee/client subscriber user chooses not to hire the potential employee/professional subscriber user, the employer/client subscriber user chooses and selects the “Ignore” button on the system application and therefore declines the prospective employee/professional from further consideration with regard to the one or more job opportunities.

The term “skills” as used herein refers to the general use of the term wherein an individual possesses particular abilities for performing a job, those skills being superior to other individuals whom do not possess those abilities. With regard to the applications “skills” also refers to the following: a “skill” is a subset of a “Skillset”. For instance, a “Skillset” can be a grouping such as “Server/Waiter/Waitress/Host/etc. . . . ”, or any other term that is understood to be associated as the equivalent of those terms By way of example, the users skill is “Server”, so the “Skillset” is the list of other words that the skill “Server” is known by “Server/Waiter/Waitress/Host etc. . . . ”. In such a scenario, when an employer subscriber user searches for the skill “Server”, the system platform displays results for all skills defined in the Skillset grouping (Server/Waiter/Waitress/Host). Every Skillset will have an equivalent in each of the languages that the system supports with these groupings defined in the database, processor backend.

There will also be a broader form of Grouping. This will cater for similar Skills in the same group. By way of example, the Skillset “Server” is mapped to a “SkillGroup” called “Restaurant”. An employee subscriber user searching for employment opportunities and enters “restaurant” into the search engine will be presented with all jobs that have the skills associated with the skill group “restaurant” which are defined in the backend (i.e. Server, Waiter, Barista, Bus Boy, Chef, Host, etc).

Additionally, employee subscriber users can enter a skill into their profile and map the skill to a predefined list of skills which will provide better search results by accessing the “Skillset” grouping criteria defined in the back end. By way of example: User works for Café de Cuba and his skill is “Food Artisan”. User enters the skill “Food Artisan” and selects an option to relate “Food Artisan” to other skills. User can then select “Food Artisan” relates to “Chef” and when an employer is search for “Chef” would appear as User's skill.

Another embodiment of the job search and employment opportunity system platform is a method that includes the processor and scheduler of the invention which can fill employment vacancies automatically on a first applied, first hired basis. By way of non-limiting example, a restaurant manager requires a dishwasher whom will be paid at a specific rate. The employer conducts a search and the system platform and scheduler will hire a dishwasher best meeting the criteria of the search (i.e., proximity, skills, skillset, experience, availability) without the requirement for the manager to manually hire the employee directly.

It is to be understood that the invention described herein refers to an app or application as well as an interface functionality via an online website. Individuals can access the system and employ use of the methods described herein by either mobile device and/or by accessing an online website via the Internet. Once the individual has established an account with the mobile and web based system, the individual, now referred to as a subscriber user, will be able to access account information, including all its functionality, by either mobile device or online via website.

Technologies employed in creating and implementing the application (i.e., “app”) for uses by a subscriber user are generally known in the art and include the following attributes. With regard to the backend layer of the software, PHP>=5.3.20 for example is employed with a Laravel programming framework. Included in the framework is Cartalyst Sentry 2, League OAuth2 Server, League OAuth2 Server Laravel and PHPUnit Laravel wrapper. With regard to the frontend desktop layer, Javascript is employed with Angular and Angular Data also on the front end. With regard to the frontend mobile layer, Phonegap is used to create a mobile wrapper for a web application. Server infrastructure is for example, Nginx (proxy server), Apache (http server), MySQL (database) with all services carried by Amazon Web Services or other similar platforms. It is to be understood that the attributes described herein which act to create and implement the invention are preferred embodiments however, other network software packages that can similarly set up the invention and as are known in the art are also envisioned and within the scope of the present invention.

As utilized, the invention herein allows several types of subscriber users to use the invention. For example, as described, an employer subscriber user is generally understood to be an individual in general or specific need of another individual whom can be employed either on a permanent or temporary basis, whether currently or in the future. An employee subscriber user is generally an individual in need of additional or new employment opportunities whether temporary in nature or permanent, either current or in the future.

Professional subscriber users are also envisioned in the present invention and can be generally be described as individual possessing skills that are currently available for hire by other individuals. It is to be understood that Professionals in this capacity will be similarly situated to employee subscriber users currently seeking new or additional job opportunities. In addition to Professionals is the existence of Clients whom can be generally described as individuals who are currently in need of another individual to provide professional services whether on an on-going basis or on a temporary basis. It is to be understood that Clients will occupy this designation and are similar in nature to employer subscriber users whom are currently in need of employees who possess a desired skill set and qualifications so to fill an available job opportunity.

The process by which each subscriber user type employs use of the claimed system and methods can be summarized as follows and merely represent examples of its use and therefore, do not limit the scope of the invention: Users can perform scenarios depending on their particular circumstance. (i.e.; I could be an (employer subscriber user) who is working as a manager in a restaurant, offering personal training session as a (professional subscriber user), working as a bartender (employee subscriber user) on weekends and also looking for an electrician (client subscriber user) for some electrical work needed at my house.) Further, a subscriber user can push open shifts and/or jobs, which may include special notes (i.e. I have had a last minute cancellation, so am willing to offer this session at a 20% discount to my normal rate if you take this session).

Employer Subscriber User

Example: A typical Employer is a user that has one or more employees working for them and wants to post shifts to available staff and view/filter their staff details.
1. Download app via but not limited to App Store®, Google® play or OpenSimSim® website Employer is presented with the homepage with three options, Get Started, Login and What is OpenSimSim®.
2. Employer will register using a unique email address or cell phone number along with a valid password and agreeing to the terms and conditions. Employer can also register using their Facebook® credentials.
3. Once registered an employer will login using their login details.
4. Employer will create a business with the following attributes.
   Business name
   Industry
   Size (number of employees)
5. Employer will setup business profile, which includes an overview about the business, availability by date and time (this could simply be the hours of operation) along with their settings and notification rules.
6. Employer will connect with employees via a connection request.
7. Employer will assign administrative roles to other managers.
8. Employer will be able to view employee's availability by skill, date and times.
9. Employer will be able to push available shifts to their employees or the OSS® world.
10. Employer will be able to view employees who are interested in filling the open shifts. This includes hourly rate, reviews and ETA. This could be a current employee or other candidates that are not current employee but have the needed skill set.
11. Employer will be able to select most appropriate employee for the given shift. This could be a current employee or other candidates that are not current employee but have the needed skill set.
12. Employer can add reviews to employee's profile.
13. Employer can provide feedback to the OpenSimSim® team regarding the application.

Employee Subscriber User

Example: A typical Employee is a user who has a working arrangement with one or more employers. (i.e. I am a bartender for Restaurant A and also a waitress at the country club).
1. Download app via but not limited to App Store®, Google® play or OSS website. Employee is presented with the homepage with three options, Get Started, Login and What is OpenSimSim®.
2. Employee will register using a unique email address or cell phone number along with a valid password and agreeing to the terms and conditions. Employee can also register using their Facebook® credentials.
3. Once registered an employee will login using their login details.
4. Employee will send out connection request.
5. Employee will be able to accept connection request.
6. Employee will setup their skills, which includes a skill overview and the hourly rate by skill.
7. Employee will add their real time availability by skill, time of day and repeat cycle.
8. Employee can push out availability changes.
9. Employee will setup their profile, which includes a bio, picture, skills (reviews for skills which can be removed), setting and notification.
10. Employee can search for available shifts from current employer or other businesses in the area.
11. Employee can view shifts that have been posted by their employer.
12. Employee can express interest in the shift.
13. Employee can view all accepted shifts, all jobs they have posted, along with all new shift opportunities.
14. Employee can provide feedback to the OpenSimSim® team regarding the application.

Professional (i.e., Employee) Subscriber User

Example: A Typical Professional is someone offering a service. (Plumber, personal trainer, golf instructor, babysitter and dentist to name a few). This type of user will have available slots of time, which they can offer to potential clients. (i.e. I am a personal trainer and have a last minute cancellation; I can push out my availability offering a discount to anyone who want to take the session.)
1. Download app via but not limited to App Store®, Google play® or OSS® website.
2. Professional is presented with the homepage with three options, Get Started, Login and What is OpenSimSim®.
3. A Professional will register using a unique email address or cell phone number along with a valid password and agreeing to the terms and conditions. Professional can also register using their Facebook® credentials.
4. Once registered a Professional will login using their login details.
5. A Professional can create a business with the following attributes.
   Business name
   Industry
   Size (number of employees)
6. A Professional will send out connection request.
7. A Professional will be able to accept connection request.
8. A Professional will setup their skills, which includes a skill overview and the hourly rate by skill.
9. A Professional will add their real time availability by skill, time of day and repeat cycle.
10. A Professional can push out availability changes.
11. A Professional will setup their profile, which includes a bio, picture, skills (reviews for skills which can be removed), setting and notification.
12. A Professional can search for available jobs.
13. A Professional can view jobs that have been posted by their clients or potential clients.
14. A Professional can express interest in a job posted.
15. A Professional can see all jobs that have been assigned to them.
16. A Professional can view all accepted jobs, all jobs they have posted, along with all new job opportunities.
17. A Professional can provide feedback to the OpenSimSim® team regarding the application.

Client (i.e., Employer) Subscriber User

Example: A typical Client is a user Looking for a Service. (i.e. I Need a Plumber on Friday Morning. I Need a Golf Instruction on Saturday Morning.)
1. Download app via but not limited to App Store®, Google play® or OSS® website. Client is presented with the homepage with three options, Get Started, Login and What is OpenSimSim®.
2. A Client will register using a unique email address or cell phone number along with a valid password and agreeing to the terms and conditions. A Client can also register using their Facebook® credentials.
3. Once registered a Client will login using their login details.
4. A Client will send out connection request.
5. A Client will be able to view the availability by skill, date and times of their connections.
6. A Client will be able to push available push available jobs to their connection and the OpenSimSim® world.
7. A Client will be able to view professionals who are interested in filling the advertised job. This includes hourly rate, reviews and ETA.
8. A Client will be able to select most appropriate user for the advertised job.
9. A Client can add reviews to a users profile for a service fulfilled.
10. A Client can provide feedback to the OpenSimSim® team regarding the application.

It is to be understood by those of pertinent skill in the art that subscriber users will occupy different user designations depending on their own particular needs. For example, an employer subscriber user can post a position currently available with their business while simultaneously acting as an employee subscriber user in applying to an available temporary or seasonal position with a business other than their own. Professional subscriber users whom seek employment opportunities by posting their availability on the system will seek available positions and push their availabilities to their respective connections and even to those subscriber users that may be outside the network connections of the Professional subscriber user seeking to sell their services. Likewise, a Client subscriber user occupies a similar position as an employer subscriber user as the Client subscriber user will post positions on their profile that they wish to have filled by one of pertinent skill and professional background.

The system app also enables employees to remain self employed or are employed by the employer directly. Other prior art describes employees whom are employed by a web-based company wherein the web-based company is acting as nothing more than a placement employer. In the present invention, employees are hired directly by the employers posting the position. Such a configuration allows for corporate oversight of all employees conducting business on behalf of the employer. It also adds clarity to the tax considerations of employers who engage and retain employees on a temporary/permanent basis.

In other words, the system app of the invention enable employers to hire employees to fill immediate needs directly without the need of third party involvement. Direct hiring of employees/professional by employers/clients is accomplished by establishment of network connections wherein individuals are in direct contact with one another whom contact one another to fill immediate and future employment needs based on geographic and time sensitive considerations.

Likewise, Professionals are individuals whom establish network connections with other subscriber users that seek the services of Professionals either on an immediate or future time, and either on a permanent or temporary (i.e., one or two shifts) basis. The retention or hiring of Professionals by subscriber users is done directly via the system app with subscriber users employing use of the system app to outline availabilities, geographic locations, ETA information, experience, job requirements, available shifts and length of employment. Importantly, Professionals are hired directly by employing subscriber users via use of the system app. As referred to herein, Professionals are understood to be interchangeable with employees.

Clients as understood in the present invention are those subscriber users that seek the services of other subscriber users (e.g., Professionals) to fulfill the needs of the Client. Again, Clients post for example, job requirements, geographic needs, available opportunities, pay rate for opportunity and length of employment wherein the Client hires the Professional subscriber user directly via the system app. As referred to herein, Clients are to be understood as interchangeable with Employers.

The system application also allows a subscriber user to gather professional recommendations that are posted to the user's account profile following each successful completed transaction wherein the user is able to add recommendations to their respective accounts for future viewing by other subscriber users. In such circumstances, in order to ensure reliability of recommendations, it is contemplated that only those subscriber users whom have engaged in Employer/Employee or Professional/Client relationships will be able to recommend or endorse the other respective party subscriber user. Moreover, the social media aspect of the system app claimed herein encourages the establishment of network connections on a perpetual basis without any involvement whatsoever with a third party web-based provider. All Employer/Employee and Professional/Client relationships are established directly between the respective subscriber users involved.

As with Facebook® and other social media web sites of the like, the social media aspects of the system app allow for exponential growth of the working and employment relationships that are established, yielding a nearly unlimited potential for a quick and efficient employee work base by establishing available real time network connections. In essence, the more network connections a subscriber user has within their network, the greater the potential to fill available job positions and likewise, the greater likelihood that subscriber user's seeking employment will be able to secure such employment using the system application. Since the system app is a mobile based device, as well as web-based, employment opportunities, such as shifts and/or opportunities that suddenly become open in the course of a working day, can be filled nearly immediately by simply accessing a mobile device, activating the system app and searching for qualified and available employees whom are within a desirable geographic location so to fill the immediate need directly.

Furthermore, the system allows a subscriber user to set up multiple profiles for various purposes. For example, a subscriber user can set up an “employee” profile that they will utilize and “push” to employers in attempts at securing a position posted by an employer. Simultaneously, the same subscriber user can set up an “employer” profile, the profile detailing the subscriber user's business information and background, and also highlighting the job opportunity that subscriber user has posted at the time. The system also allows a subscriber user to set up a “business” profile to which the subscriber user can be set up as an “Administrator” of the business being profiled.

As described herein, the invention, initially, will provide subscriber users with an unlimited number of push notifications in order to establish connections and engage in business matters pertaining to the system application. After a specified period of time, the number of push notifications will be limited depending on whether a particular subscriber user provides payment information to acquire additional features including but not limited to push notifications beyond the number already provided by the system application.

As envisioned herein, the subscriber user's reputation and recommendations by prior employers, employees, professionals and clients will also be visible to the user's network connections. Those statuses can also be pushed to such network connections as well as to those subscriber users that may be outside the network of the subscriber user. Subscriber users who are seeking to fill an available permanent or temporary position will also be able to search other subscriber users by employing the use of a filter that analyzes qualifications, geographical location, past work history as well as reputation and recommendations of the subscriber user being considered for employment. Likewise, employee subscriber users seeking employment opportunities can employ a filter of the system that narrows search criteria to job types, geographical location, industry, reputation and “recommendations” associated with the employer/client and other attributes of the employer/client. The search engine and filter will also act automatically to generate search results that are pertinent and which relate to the subscriber user's needs.

Accordingly, the system claimed herein allows a subscriber user to tailor their search and search criteria manually, and will also provide a system that retrieves search results based on an automatic computer analysis that is based on the subscriber user's profile information and job posting criteria and requirements. Significantly, a preferred embodiment of the invention is that the system allows a subscriber user to engage other subscriber users on a more personal and interactive level than has been previously allowed in the prior art for employees and employers to fill available shifts “on the fly” and on an as needed basis versus the traditional method of advertising, interviewing and hiring. Hence, the social media aspect of the system is a critical aspect of the invention. The system described herein allows a subscriber user the ability to act proactively, as well as in an automated fashion, in engaging suitable network connections in establishing online and non-online business relationships with individuals with whom the subscriber user can seek employment opportunities either currently or at some point in the future, all in a convenient mobile device implemented system.

In a preferred embodiment, search results generated by the system allow the subscriber user to push their current availability to other subscriber users seeking to fill temporary or permanent positions. Likewise, as the system allows for proactive and real time interactions with colleagues, network connections and non-network connections, and does so by pushing availabilities and posted job postings to potentially interested subscriber users. Proactive interaction however, also includes the ability of network subscribers to engage in online chat sessions, in real time, including the ability to set up video chats in real time, with chat sessions being capable of being conducted via mobile device from any location regarding immediate job opportunities and hourly shifts.

The system application further allows a subscriber user the ability for real time push notification of job opportunities and job availability for an employee and/or professional. For example, a subscriber user can be an employee subscriber user and can push out their availability changes in real time. In addition, as a professional subscriber user, the user can push out their availability for jobs in real time. For instance, the user may have a cancellation and want to update other subscriber users with the new availability.

The system application also provides a calendar function and a scheduler wherein once a subscriber user has accepted one or more jobs, the system application synchronizes the details of the job shift or position to the subscriber user's calendar and calendar of choice. In a preferred embodiment of this element, once a shift and/or job has been accepted, the system app will upload the details of the shift and/or job to the users calendar on their device (Gmail®, Outlook®, Yahoo®, etc.). Employee/professional subscriber users can publish their availability for employment opportunities in a variety of manners, giving employers greater insight to available resources and individuals whom can fill available hourly shifts, temporary work, or even permanent placement.

The mobile device implemented job placement and recruitment system also provides subscriber users with a Reminder function wherein a subscriber user can set a reminder for future job and/or shifts within the system application “app”. Reminders can be set for all accepted jobs and/or shifts. The reminders appear in the form of a pop-up or a status bar notification and can be set for any length of time before the job and/or shift with the system app allowing the subscriber user to set more than one reminder if necessary for multiple accepted jobs. A subscriber user can also turn off the reminder feature through their system application “app” settings.

With regard to employee/professional subscriber users publishing their availability to take on new job opportunities and hourly shifts as they arise, the methods of the present invention also provide for a scheduler that provides various modes of availability (available, unavailable, peak demand available and reserved available).

In particular, four modes of availability comprise elements of the invention; Available, Unavailable, Reserved Availability and Peak Demand Availability (variable availability). The following provides a description of each particular mode and scheduler. Accordingly, the invention further provides subscriber users with various options in creating the claimed scheduler, unavailable, available, reserved available and peak demand available periods of time and availability.

By way of non-limiting example, employee/professional subscriber users utilize the “reserved availability” mode wherein for example, an employee inputs and publishes his availability into his scheduler on the system application so that it is visible to employer/client connections. With reserved availability, an employer or client subscriber user can thereafter reserve the available time of that individual employee or professional subscriber user has designated as reserved available on the employee's scheduler.

Available (Availability)—For available periods of time, an employee/professional subscriber user inputs and publishes into his scheduler the time and days the employee is available to work. This is the employee/professional subscriber user's base availability setting and will comprise a default availability outside of any reserved or peak demand availability. If the employee/professional subscriber user is not employed their availability will be designated in the unavailable, available or peak demand available modes only. Employee/professional subscriber users input time and days on which they are available to work into the scheduler of the invention. The scheduler is published to the system platform so that the availability period of time is viewable to a plurality of employer subscriber users whom conduct a search for qualified employees to fill available shifts and employment opportunities. In a preferred embodiment an employee subscriber user will share network connections with each of the plurality of employer subscriber users conducting a search however, during instances in which qualified employee network connections aren't available for employment, the invention system platform allows for employers to search for employees outside of their network connections as well.

During an employee's designated available period of time, the period of time is known as an employee's availability for employment and is defined in part by the employee's available time frame in which to accept employment.

Unavailable (Unavailability)—For unavailable periods of time a subscriber user (i.e., professional/employee subscriber user) selects the time and days they are not available to work and inputs the information into the scheduler and publishes the availability information to the system platform. This means employer/client subscriber users will not be able to schedule them for employment or for work shifts. If employers are searching to fill shifts, the worker will not show up in the search criteria. However, the worker can still be invited to a shift if the worker is part of the employer/client subscriber user's network. In such an instance wherein an employee possessing particular skills is unavailable as indicated by his published scheduler, an employer requiring the employee's skills, can “push” an employment opportunity invitation to the employee for work during a period of time when the employee has indicated he is unavailable to work. Such an invitation can be pushed to the employee even though the employee has designated the time on his scheduler as unavailable giving the employee the option of either accepting or not accepting the employment. This type of employee/professional availability is designated as a period of unavailability.

Variable Availability (aka Peak Demand Availability)—Peak demand available periods of time are an option for employees and employers as well as clients and professionals. For employees, these individuals mark an availability period as not available into their scheduler but apply a setting where they input an hourly rate that lets the system application know that if someone is willing to pay them at or above this then the employee will be available for the job/shift opportunity. When the threshold is met, the employee becomes available and would like to be notified of the shift/job. For the employers that are looking for workers, they can move a sliding scale (i.e., a slider) that allows for adjustment of an hourly rate, upward or downward, to see if more people become available at higher rates of pay.

Accordingly, employee or professional subscriber users can input their availability into the scheduler so that they become available to accept employment opportunities once an hourly rate threshold is met or surpassed. Once an employer meets or surpasses the employee's desired hourly rate, then the employment opportunity is pushed to the employee for either their acceptance or refusal in taking the position. Such period of availability are typically designated as variable availability and otherwise known as peak demand availability.

By way of non-limiting example peak demand availability is described in the following scenario, an employee/professional subscriber user inputs and publishes the time and days that they are available to work into the scheduler but only for a specific, designated desired rate of pay. Scenario: Employee wants the weekend off but is willing to work the weekend for employer willing to pay $20 per hour or more. The employee inputs and publishes the days, times into his scheduler and designated this time period as their peak demand availability. This means that when an employer is searching to fill a shift and puts in a rate of $20 or more, the worker will appear as available. However, if the rate in the employer search is below $20, the worker will not appear in the search results of employers searching for available help. The employer will have a slider at the bottom of the scheduler which they can move from left to right (increasing and decreasing the rate of pay) and as they move the slider, wherein workers who meet the rate criteria will appear. By way of scenario, if an employer has an emergency where he needs to get staff in on the weekend immediately, he can slide the bar to the right increasing the rate the employer is willing to pay to see who appears in the search.

Reserved Availability—For reserved availability employer/client subscriber users view a worker's available time in the scheduler and will reserve the time and days the employee has agreed to make themselves available to the employer based upon the time input and published as reserved availability in the employee's scheduler. In reserving the employee's time, the employer has reserved a right of first refusal in obtaining the employee's availability work an employment opportunity the employer is looking to staff. Once the employer creates his shift schedules and publishes them to the scheduler and system platform of the invention, the system application will release any unused reserved availability the employer may have reserved so other employers can schedule the employee for the unused time. Changes made by the employer whom has reserved time will automatically be made in the employee's scheduler. This allows the employee to share their real time availability with multiple employers while still committing availability to each so there is no conflict between employers.

By way of a non-limiting scenario, Café A reserves an employee's morning availability, Café B reserves the employee's afternoon availability and Café C reserves the employee's night time availability. Accordingly, the reserved availability of each is no longer viewable to employers that did not reserve the availability. However, once the schedules are published any unused reserve availability will be released and made available and viewable to all employers. The employee will now appear as available on his scheduler to any employers looking for workers during the released reserved availability.

The methods further provide a system platform that allows employer and client subscriber users to reserve the future availability of a particular employee/professional subscriber user in 2 or 3 dimensions. For example, in 2-dimensional reserved availability, Employer A is able to view the future availability of Employee B on Employee B's scheduler calendar, Employee B being a particularly sought and skilled individual. Employer A reserves a block of future availability for Employee B for a specific date and time period. In such a scenario, Employee B's availability is no longer visible to any of Employee B's network connections, other than to Employer A.

In the aforementioned example, Employer A has the right of first refusal in either retaining the services of Employee B or not retaining those services. At a given time period prior to or during the period of reserved availability, Employer A is at liberty to decline retaining the services of Employee B at which time the reserved availability no longer applies and Employee B's availability once again is released to other employer subscriber users and becomes visible to other Employer/Client subscriber users within Employee B's network.

Employee B can also remove his reserved availability despite having his reserved availability secured such as in situations in which the reserved availability can no longer be provided to the reserving Employer A. In such situations, Employee B removes his reserved availability and Employer A is notified that the reserved availability has been removed. Employer B is responsible for securing a replacement for the services by locating a competent replacement for Employee B. For example, in the event Employer A reserved the availability of Employee B on a particular date and time as a bartender, and Employee B was unable to fulfill his obligation due to an emergency or inability to do so, then Employer A would be tasked with and responsible for locating another comparably skilled bartender whom would replace Employee B's position as a bartender in Employers A establishment.

Methods of reserved availability are also 3 dimensional. In such a scenario, Employer A is able reserve the future work availability of Employee B, wherein for example, Employee B is reserved, at a particular day and time, to provide personal fitness training services for Employer A. Meanwhile Employee B (i.e., Fitness Trainer) in turn, schedules other prospective clients during a particular day and time other than the day and time reserved by Employer A. In the event, Employer A cancels his reserved time with Employee B, then the availability of Employee B opens up and becomes visible on the system platform to other prospective clients within Employee B's network, thereby allowing such prospective clients the ability to reserve future availability of a particular day and time to be trained by Employee B.

Further to 3-dimensional reserved availability, Employer A can reserve the future availability of Employee B wherein Employee B schedules Client C for a work out session. In this scenario, Client C has utilized 3-dimensional reserved availability on the system platform in order to schedule a reserved future availability with Employee B. In the event Client C cancels his appointed time with Employee B for a fitness session, the system application then releases the reserved time previously held by Client C and opens the time to other prospective customers in Employee B's network connections. Also related to the scheduler is the element of a two-sided network. By way of non-limiting example, Café de Cuba uses OpenSimSim for scheduling and some of their employees work for other employers. These employees invite their other employers to OpenSimSim who then use the system to schedule their employees. This growth continues to build the network which in turn makes the network valuable to both employers and employees as the network grows. Using the scheduler across multiple employers on a single platform to build the network is the novel aspect

Recruitment

Further with regard to recruitment, the system application provides employers the ability to post a job advertisement and have any user in the system application network apply. Posters can add a full description of the job including geographical location, job description, time zone requirements, job requirements, questions for the applicant to answer, video message that includes details of the job and possible interview type questions. Employers can also assign hiring managers who will receive the job applications. Employers can search for skills sets within a geo-location or in a particular time zone. The system application network will present the user with a map showing the search results and the employer can scroll to view the possible applicants/workers details and make a decision if they want to connect with that user. Employers will categorize the applications received in order to keep track of the hiring process (e.g. received, shortlisted, not suitable, interviewed, accepted, declined). Employees will “like” businesses and in return they will receive email notifications when there are employment opportunities.

Employers will specify the availability mode they are looking in an employee (i.e., available, unavailable, reserved available, peak demand available) as part of the job posting process. The system application network backend will be able to search and suggest suitable candidates from the system application network based on geographical location, availability and skills. Employer subscriber users can also view the employee subscriber user's profile to include information such as the numerous business locations the employee has worked along with the number of shifts at each employer location. Employer users can view the employee user's availability to see to how it fits in with their needs.

Workers can complete a profile including their contact info, skills, skill sets (skillset), skill groups (aka skillgroup) history, recommendations along with uploading their resume and attaching a video of themselves for prospective employers to view. Employees/professionals can view employer pages in the system application network and view what job opportunities they have available and apply if they meet the requirements.

If employee/professionals allow the system application network to track their geo-location in the background, the system application network will let them know of job opportunities based on their real-time geographical or time zone location. The same principle will apply when an employer in which the system application network lets employers know when there are employees nearby that match job opportunity criteria that's already advertised.

The invention further relates to a method comprising identifying a plurality of members of a web and mobile-based implemented job placement recruitment system, social networking application (“app”), with each of the plurality of members having a member profile. The web and mobile-based implemented job placement recruitment system, social networking application identifies a plurality of employee subscriber users for employment opportunities, with the method comprising a computer processor that identifies employee subscriber users relative to one another based on particular skills, experience levels and availabilities for short or long term job placement. The method generating a scheduler of availability for each individual employee subscriber user, wherein the scheduler is generated when the individual employee subscriber user inputs time and days into the scheduler on which the individual employee subscriber is available and unavailable to accept employment opportunities. The web and mobile-based implemented job placement recruitment system, social networking application displays and publishes the time and days in the scheduler with the time and days making up availability information. A plurality of employer subscriber users search the availability information of the plurality of each of the employee subscriber users with an individual employer subscriber user viewing the availability information and scheduler of the individual employee subscriber user and hires the individual employee subscriber user for an employment opportunity. Thereafter, the scheduler depublishes the availability information corresponding to the available period of time hired at the moment the employer subscriber user hires the employee subscriber user.

The method relates further to availability information made up of numerous availability modes including availability, unavailability, peak demand availability or reserved availability periods of time. The method also generates the scheduler when an individual employee subscriber user inputs time and days into the scheduler on which he is available and unavailable for accepting employment opportunities, the time and days making up availability information. The system application thereafter, publishes the availability information so the information is viewable by the plurality of each of the employer subscriber users whom conduct a search for qualified employees and whom are seeking qualified employees to fill available employment opportunities on a temporary or permanent basis, with searches generating search result lists. In a preferred embodiment, the individual employee subscriber user is a part of each of the plurality of employer subscriber user's network connections, with the individual employer subscriber user hiring the individual employee subscriber user during an available period of time published on the scheduler.

The method also includes generating the scheduler wherein the individual employee subscriber user inputs time and days into the scheduler during time the individual employee subscriber user is unavailable for accepting the employment opportunities. Thereafter the scheduler prevents the availability information of the individual employee subscriber user from being viewable and searchable by each of the plurality of employer subscriber users during the period of unavailability. An individual employer subscriber user is then at liberty to push an invitation for a particular employment opportunity to the individual employee subscriber user giving the individual employee subscriber user the option of either accepting or not accepting the particular employment opportunity. This mode of availability is designated as a period of unavailability as further described above.

The method further includes generating the scheduler by identification of a qualified employee subscriber user by the employer subscriber user after conducting the search, with the qualified employee subscriber user possessing the requisite skills for the particular employment opportunity. To do so, the employer subscriber user views the qualified employee subscriber user's availability information and the employer subscriber user reserves a particular period of availability, the reserved particular period of availability thereafter no longer being viewable or searchable by the each of the plurality of employer subscriber users in subsequent searches. This mode of availability is designated as reserved availability.

The method further relates to generating the scheduler to include the individual employee subscriber user inputting time and days into the scheduler on which the individual employee subscriber user is unavailable to accept the employment opportunity below a desired rate of pay, but is available to accept the employment opportunity at or above the desired rate of pay. The system then publishes the availability information so that the information is viewable by each of the plurality of employer subscriber users whom conduct a search for qualified employees. Ideally, the individual employee subscriber user is part of each of the plurality of employer subscriber user's network connections. Upon locating a suitable candidate the employer subscriber user hires the qualified employee subscriber user during an available period of time on the scheduler by offering a pay rate at or above the desired rate of pay. Once offer is tendered, the scheduler depublishes the availability information corresponding to the available period of time. This mode of availability is designated as the individual employee subscriber user's peak demand availability.

The method further relates to generating the scheduler with the individual employer subscriber user conducting the search of the plurality of employee subscriber users by engaging a slider, wherein the individual employer subscriber user conducts the search by including varying rates of pay in search criteria by adjusting the slider upward or downward to correspond with increasing or decreasing rates of pay to be offered. The search generates a search results list of a qualified pool of skilled employee subscriber users whose minimum pay rate for acceptance of employment is met by the rate offered by the particular employer subscriber user engaging the slider. In an embodiment of the invention, the social networking application and scheduler hires the individual employee subscriber user automatically. It is to be understood that an individual employee subscriber user's status will be converted to one designated as a hired individual employee subscriber user once he or she is hired by an employee to staff an available employment shift opportunity.

The invention further relates to a web and mobile-based implemented job placement recruitment system, social networking application (“app”), that includes a scheduler of availability and computer processor, the scheduler including time and days in which an individual employee subscriber user is available and unavailable for accepting employment opportunities. The web and mobile-based implemented job placement recruitment system, social networking application also includes a plurality of members, each of the plurality of members having a member profile, wherein the computer processor includes identification of a plurality of employee subscriber users for employment opportunities. The computer processor further includes identification of employee subscriber users relative to one another based on particular skills, experience levels and availabilities for short or long term job placement. Identification of the employee subscriber users includes generating the scheduler of availability for each individual employee subscriber user, with the scheduler being generated when an individual employee subscriber user inputs the time and days into the scheduler on which the individual employee subscriber is available and unavailable to accept employment opportunities. These selected time and days make up availability information, wherein the availability information is published on the web and mobile-based implemented job placement recruitment system, social networking application so that it is viewable by a plurality of employer subscriber users whom conduct a search for qualified employees and whom are seeking qualified employees to fill available employment opportunities on a temporary or permanent basis. With regard to the search, the search generates a list of search results, wherein the employee subscriber user a network connection to each of the plurality of employer subscriber users, wherein an employer subscriber user hires the employee subscriber user during an available period of time on the scheduler. Thereafter, the scheduler depublishes the availability information corresponding to the available period of time hired at the moment the employer subscriber user hires the employee subscriber user.

The web and mobile-based implemented job placement recruitment system, social networking application further includes the scheduler which includes time and days for which the employee subscriber user is unavailable for accepting the employment opportunities. When an employee subscriber user is unavailable, the scheduler prevents the employee subscriber user from being searchable by each of the plurality of employer subscriber users during the period of unavailability. However, the employer subscriber user is still able to “push” an invitation to the employee subscriber user thereby giving the employee subscriber user the option of either accepting or declining the particular employment opportunity.

The web and mobile-based implemented job placement recruitment system, social networking application includes the computer processor which identifies the employee subscriber user after the search is conducted. Identification of the employee subscriber user includes recognizing that the employee subscriber user possesses the requisite skills for a particular employment opportunity, wherein the employer subscriber user views the employee subscriber user's availability information and scheduler. Thereafter, the employer subscriber user reserves a period of availability, the reserved particular period of availability thereafter no longer being viewable or searchable by each of the plurality of employer subscriber users in subsequent searches. The reserved period of availability makes up the employee subscriber user's period of reserved availability.

The web and mobile-based implemented job placement recruitment system, social networking application further includes am employee subscriber user whom is unavailable to accept an employment opportunity below a particular desired rate of pay and is available to accept the employment opportunity at or above the desired rate of pay. The selected time and days makes up availability information. The social networking application publishes the availability information so that the information is viewable by each of the plurality of employer subscriber users whom conduct a search for qualified employees and whom are seeking qualified employees to fill available employment opportunities on a temporary or permanent basis. Ideally, the employee subscriber user is part of each of the plurality of employer subscriber user's network connections, wherein the employer subscriber user hires the employee subscriber user during an available period of time on the scheduler by offering a pay rate at or above the desired rate of pay, wherein once offer is tendered, the scheduler depublishes the availability information corresponding to the hired period of time. This mode of availability is known as an employee subscriber user's peak demand availability.

The scheduler includes a slider, wherein the employer subscriber user conducts the search of a plurality of employee subscriber users by engaging the slider. The employer subscriber user conducts the search by including varying rates of pay in search criteria by adjusting the slider upward or downward to correspond with increasing or decreasing rates of pay to be offered. The search results generate a list of qualified pool of skilled employee subscriber users whose minimum pay rate is met by the rate offered by the employer subscriber user engaging the slider.

Yet another preferred embodiment of the invention is a machine-readable storage medium that includes a server and computer processor including instructions, which when executed by the machine, cause the machine to: identify employee subscriber users relative to one another based on particular skills, experience levels and availabilities for short or long term job placement. The storage medium also generates a scheduler of availability, wherein the scheduler is generated by an individual employee subscriber user inputting times and days into the scheduler on which the individual employee subscriber is available and unavailable to accept employment opportunities. The machine-readable storage medium then publishes the times and days in the scheduler. The time and days making up availability information. Individual employer subscriber user view the availability information and hires the individual employee subscriber user for an employment opportunity. The machine-readable storage medium includes availability information that is made up of various availability modes including availability, unavailability, variable availability or reserved availability periods of time.

The machine-readable storage medium also generates the scheduler to include input of a time and days into the scheduler on which the individual employee subscriber user is available and unavailable for accepting employment opportunities. This time and days make up availability information. The machine-readable storage medium publishes the availability information on machine-readable storage medium so that the information is viewable by each of the plurality of employer subscriber users whom conduct a search for qualified employees and whom are seeking qualified employees to fill available employment opportunities on a temporary or permanent basis. The machine-readable storage medium generates search results wherein the individual employee subscriber user is part of each of the plurality of employer subscriber user's network connections. Thereafter, the individual employer subscriber user hires the individual employee subscriber user during an available period of time published on the scheduler. The scheduler then depublishes the availability information corresponding to the available period of time hired at the moment the employer subscriber user hires the employee subscriber user.

The machine-readable storage medium also generates the scheduler by input of time and days by the individual employee subscriber user into the scheduler during times the individual employee subscriber user is unavailable for accepting the employment opportunities, wherein the scheduler prevents the availability information of the individual employee subscriber user from being viewable and searchable by the plurality of employer subscriber users during the period of unavailability. The individual employer subscriber user can then push an invitation for a particular employment opportunity to the individual employee subscriber user giving the individual employee subscriber user the option of either accepting or not accepting the particular employment opportunity.

The machine-readable storage medium further generates the scheduler by identifying a qualified employee subscriber user after an employer subscriber user conducts the search. In such a search, the qualified employee subscriber user possesses the requisite skills for the particular employment opportunity. The employer subscriber user views the qualified employee subscriber user's availability information, wherein the employer subscriber user reserves a particular period of availability. The reserved particular period of availability thereafter is no longer being viewable or searchable by the each of the plurality of employer subscriber users in subsequent searches. This mode of availability is designated as an employee subscriber user's reserved availability.

The machine-readable storage medium also generates the scheduler including: the individual employee subscriber user inputting time and days into the scheduler on which the individual employee subscriber user is unavailable to accept the employment opportunity below a desired rate of pay, but is available to accept the employment opportunity above the desired rate of pay. This time and days makes up the employee subscriber user's availability information. The machine-readable storage medium publishes the availability information so that the information is viewable by each of the plurality of employer subscriber users whom conduct a search for qualified employees and whom are seeking qualified employees to fill available employment opportunities on a temporary or permanent basis. Ideally, the individual employee subscriber user is part of each of the plurality of employer subscriber user's network connections, wherein the employer subscriber user hires the employee subscriber user during an available period of time on the scheduler by offering a pay rate above the desired rate of pay, once offer is tendered, the scheduler depublishes the availability information corresponding to the available period of time. This mode of availability is designated as an individual employee subscriber user's peak demand availability.

The machine-readable storage medium also includes generating the scheduler further to include an individual employer subscriber user conducting the search of the plurality of employee subscriber users by engaging a slider. The individual employer subscriber user conducts the search by using the slider to include varying rates of pay in search criteria by adjusting the slider upward or downward to correspond with increasing or decreasing rates of pay to be offered, generating a search results list of a qualified pool of skilled employee subscriber users whose minimum pay rate for acceptance of employment is met by the rate offered by the particular employer subscriber user engaging the slider. These modes of availability can be created in two or three-dimensions for the methods, the machine-readable storage medium or to the web and mobile-based implemented job placement recruitment system, social networking application as described herein above.

In a preferred embodiment the invention comprises a method of staffing available employment shift opportunities comprising identifying a plurality of members of a web and mobile-based implemented job placement recruitment system, social networking application (“app”), with each of the plurality of members having a member profile. The web and mobile-based implemented job placement recruitment system, social networking application includes a computer processor and database wherein each of the plurality of members can establish network connections with one another.

The method also includes identifying a plurality of employee subscriber users from the plurality of members to staff the available employment shift opportunities by means of a candidate search and search engine and identifying qualified employee subscriber users from the plurality of members relative to one another based on particular skills, experience levels and availabilities for short or long term job placement for the available employment shift opportunities.

The method further generates a scheduler of availability for each qualified individual employee subscriber user to be viewed by an individual employer subscriber user wherein the scheduler is generated when an individual employee subscriber user inputs time and days into the scheduler on which the individual employee subscriber is available and unavailable to accept employment opportunities. The method further displaying and publishing the time and days in the scheduler on the web and mobile-based implemented job placement recruitment system, social networking application (“app”), with the time and days being availability information.

The method further generates the availability information based on information gathered by means of an internet source and geolocation (such as for example Google® “Popular Times”) of each qualified individual employee subscriber user with the method searching the availability information of the plurality of the qualified employee subscriber users by means of the search engine. The method then generates a work history of each of the qualified individual employee subscriber users including experience hours worked by means of geolocation. Further, the individual employer subscriber user hires an appropriately qualified individual employee subscriber user to staff the employment shift based on the qualified individual employee subscriber user's experience hours and the system application depublishes the availability information corresponding to the hired employee subscriber user at the moment the individual employer subscriber user hires the hired employee subscriber user. The qualified individual employee subscriber user then generates new experience hours, to be stored on his member profile, by activating the web and mobile-based implemented job placement recruitment system, social networking application (“app”) at the beginning of a work shift and deactivating at the end of the work shift. The system and method stores the experience hours on the qualified individual employee subscriber user's member profile so that the experience hours are tallied for the hired employee subscriber user and added to the hired employee subscriber user's member profile so that it is viewable by future prospective employer subscriber users.

In yet another preferred embodiment the invention includes a method of staffing available employment shift opportunities that includes a web and mobile-based implemented job placement recruitment system, social networking application (“app”), the method including a plurality of members having a member profile, each member being either an employee subscriber user or an employer subscriber user. The web and mobile-based implemented job placement recruitment system, social networking application further includes a computer processor and database wherein a qualified individual employee subscriber user identifies a plurality of available employment shift opportunities with a search engine with the available employment shift opportunities being identified by means of an internet source and geolocation.

With the method, an individual employer subscriber user identifies a plurality of qualified employee subscriber users whom are seeking short or long term employment opportunities with the search engine. The system further notifies the qualified individual employee subscriber user of the existence of the available employment shift opportunities wherein the qualified individual employee subscriber user meets the qualifications of the available employment opportunity. In this embodiment the qualified individual employee subscriber user was previously employed by the individual employer subscriber user but is no longer employed as such.

The method further notifying the individual employer subscriber user of the availability of the qualified individual employee subscriber user to accept the available employment shift opportunity and generating a scheduler of availability associated with the qualified individual employee subscriber user to be viewed by the individual employer subscriber user wherein the scheduler is generated when the qualified individual employee subscriber user inputs time and days into the scheduler on which the qualified individual employee subscriber is available and unavailable to accept employment opportunities.

The web and mobile-based implemented job placement recruitment system, social networking application further displays and publishes the time and days in the scheduler, the time and days comprising availability information. The system further generates the availability information based on information gathered by means of an internet source and geolocation such as for example, Google® “Popular Times” functionality. Thereafter, the individual employer subscriber user hires the qualified individual employee subscriber user to staff the available employment shift opportunity based on the qualified individual employee subscriber user's historical connection to the individual employer subscriber user. The qualified individual employee subscriber user generating experience hours when the qualified individual employee subscriber user activates the web and mobile-based implemented job placement recruitment system, social networking application (“app”) at the beginning of a work shift and deactivating at the end of the shift.

The system further stores the experience hours on the qualified individual employee subscriber user's member profile so that the experience hours are tallied and added to the qualified individual employee subscriber user's member profile so that it is viewable by prospective employer subscriber users.

In yet another embodiment, the invention includes a method of optimizing employer staffing that includes the steps of an individual employer subscriber user accessing a web and mobile-based implemented job placement recruitment system, social networking application (“app”) wherein the web and mobile-based implemented job placement recruitment system, social networking application includes a computer processor and database. The system accesses peak and non-peak business days and times by means of an internet source and geolocation including for example, Google® “Popular Times” functionality. With the embodiment, the system displays the peak and non-peak business days and times on a web and mobile-based implemented job placement recruitment system, social networking application (“app”) interface and also simultaneously displays a shift schedule prepared by an employer subscriber user on the web and mobile-based implemented job placement recruitment system, social networking application (“app”) interface. The system overlays the peak and non-peak business days and times onto the shift schedule so that the employer subscriber user can view the data points simultaneously.

Thereafter, the employer subscriber user assessing its staffing needs based on the graphical overlay and determining if staffing is sufficient and will hire staff members according to the needs of the shift schedule and the geolocation/internet source information.

Yet another preferred embodiment of the invention includes a web and mobile-based implemented job placement recruitment system, social networking application (“app”) that includes a computer processor and database and a scheduler of availability. The scheduler includes time and days in which a qualified individual employee subscriber user is available and unavailable for accepting employment opportunities, wherein all employee subscriber user members create a scheduler of availability. The database stores member profile information for a plurality of subscriber user members, each of the plurality of members establishing network connections with one another.

The computer processor identifies a plurality of employee subscriber users whom are seeking employment opportunities by means of a search engine. The computer processor identifies a plurality of employer subscriber users whom are seeking to hire qualified employee subscriber users for available employment shift opportunities. The computer processor further identifies a plurality of qualified employee subscriber users relative to one another based on particular skills, experience levels and availabilities for short or long term job placement and ranking the employee subscriber users.

The scheduler of availability for the qualified individual employee subscriber user includes the qualified individual employee subscriber user inputting the time and days into the scheduler on which the qualified individual employee subscriber is available and unavailable to accept employment opportunities. The selected time and days comprise availability information, with the availability information published on the web and mobile-based implemented job placement recruitment system, social networking application so that it is visible by the plurality of employer subscriber users whom access the search engine to conduct a search for individual qualified employee subscriber users to fill available employment opportunities on a temporary or permanent basis.

Further, the availability information is generated based on information gathered by means of an internet source and geolocation such as for example Google® “Popular Times”. Further, the search includes a results list, wherein an individual employer subscriber user hires the qualified employee subscriber user during an available period of time on the scheduler based on the qualified employee subscriber user's experience hours and/or historical connection to the employer subscriber user. Thereafter, the scheduler depublishes the availability information of the qualified individual employee subscriber user at the moment the individual employer subscriber user hires the qualified employee subscriber user.

In yet another embodiment, the invention includes a web and mobile-based implemented job placement recruitment system, social networking application (“app”), that includes a computer processor and database and a scheduler of availability. The scheduler includes time and days in which an individual employee subscriber user is available and unavailable for accepting employment opportunities. Further, the database stores member profile information for a plurality of subscriber user members, each of the plurality of members establishing network connections with one another.

Further, the computer processor identifies a plurality of qualified employee subscriber users whom are seeking employment opportunities by means of a search engine; wherein the computer processor identifies the plurality of qualified employee subscriber users relative to one another based on particular skills including, experience levels, experience hours, historical connection and availabilities for short or long term job placement and ranking the employee subscriber users. The scheduler of availability for an individual employee subscriber user includes the individual employee subscriber user inputting the time and days into the scheduler on which the individual employee subscriber is available and unavailable to accept employment opportunities. The selected time and days make up availability information, wherein the availability information is published on the web and mobile-based implemented job placement recruitment system, social networking application so that it is viewable by a plurality of employer subscriber users whom access the search engine to conduct a search for qualified individual employee subscriber users seeking to fill available employment shift opportunities on a temporary or permanent basis.

As part of system, the search includes a results list, wherein an individual employer subscriber user hires a qualified individual employee subscriber user during an available period of time on the scheduler based on the qualified individual employee subscriber user's experience hours and historical connection to the individual employer subscriber user. The system thereafter depublishes the scheduler and availability information corresponding to the individual employee subscriber user's at the moment the individual employer subscriber user hires the individual employee subscriber user.

And yet another preferred embodiment of the invention includes a web and mobile-based implemented job placement recruitment system, social networking application (“app”) to optimize employer staffing that includes a computer processor wherein the computer processor accesses peak and non-peak business days and times from an interne source by means of geolocation such as for example, Google® “Popular Times” functionality. The system further displays the peak and non-peak business days and times on a web and mobile-based implemented job placement recruitment system, social networking application (“app”) interface. The system also displays a shift schedule prepared by the employer subscriber user on the web and mobile-based implemented job placement recruitment system, social networking application (“app”) interface. The system further graphically overlays the peak and non-peak business days and times onto the shift schedule so that the employer subscriber user can view the two data points simultaneously on the interface. Thereafter, the employee subscriber user assesses its staffing needs based on the graphical overlay and determines if staffing is sufficient.

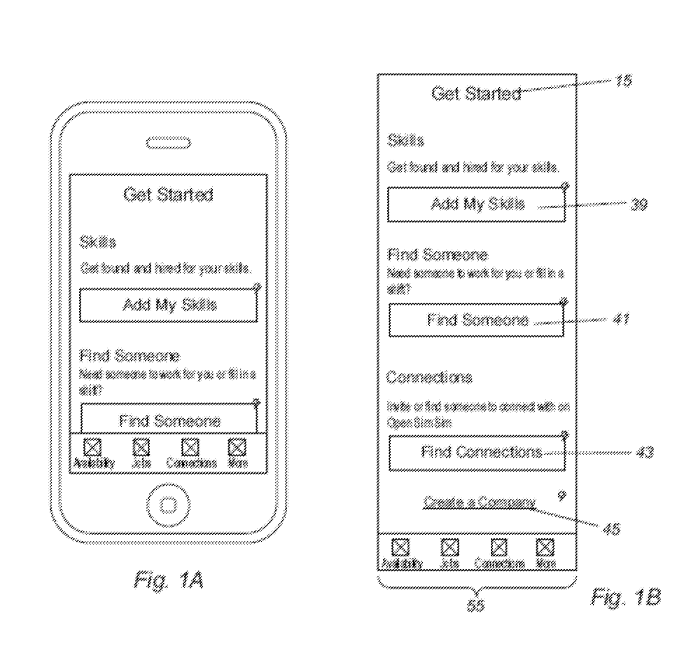

Turning now to the substance of FIGS. 1 to 25 and the preferred embodiments of the invention.

FIGS. 1A and 1B illustrate a preferred embodiment of an electronic page of the invention wherein a subscriber user can access additional pages in which to add skills 39 and to search for a skill within a location between a date and time range from their connections or anyone registered with the system app 41 or even search for connections and/or invite connections via email or cell phone whom are not associated as a subscriber user 42. The page also enables a subscriber user to create and edit information associated with a particular company that is seeking qualified employees/clients for available work shifts or looking for services 43. Also provided are shortcut buttons 55 that a subscriber user accesses to forego advancing through unnecessary pages.

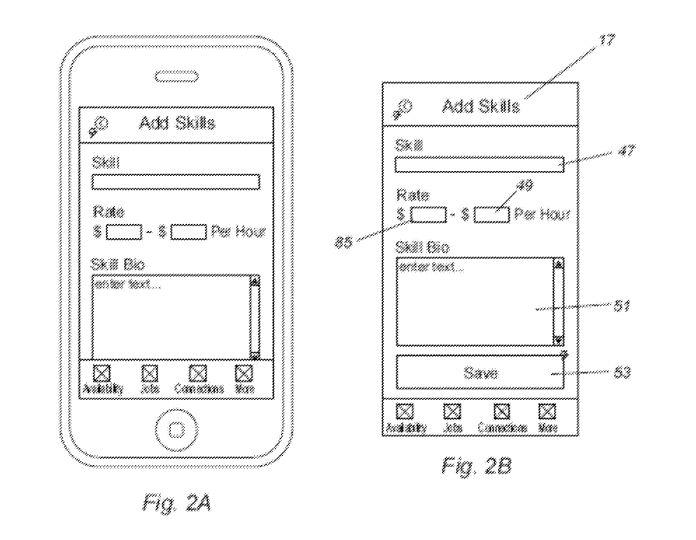

FIGS. 2A and 2B illustrate a preferred embodiment of an electronic page 17 of the invention wherein a subscriber user enters and saves skills 53, experience 47, 51 and hourly pay rate sought 85, 49. As envisioned, elements herein are not limited by the illustrations provided and other information can be incorporated into each of the electronic pages described.

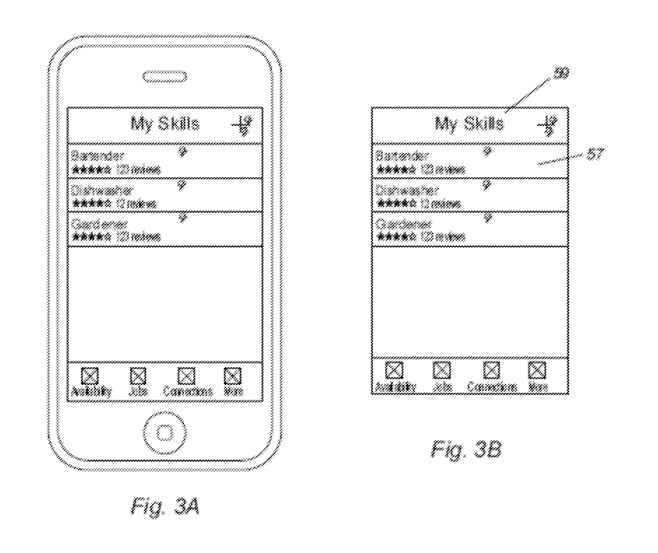

FIGS. 3A and 3B illustrate a subscriber user's account profile page subsequent to the user entering prior work history information into their account. Specifically, the subscriber user enters information into the “My Skills” page 59 pertinent to their prior work history and experience. Thereafter, each of the user's previous work positions is displayed in a listing 57 that is viewable to other subscriber users with whom there is an established network connection.

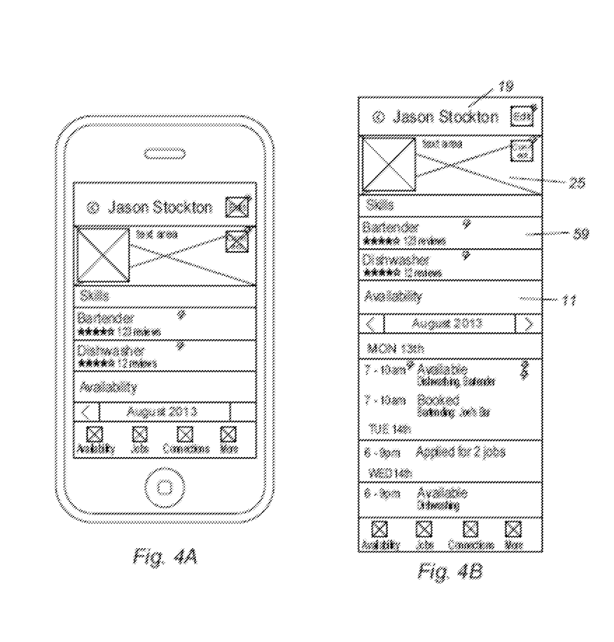

FIGS. 4A and 4B illustrate a preferred embodiment of the subscriber user profile electronic page associated with a subscriber user's account including but not limited to name 19, picture and bio 25, skills 59, recommendations 59 and availability profile 11. Specifically, as illustrated, a subscriber user can enter text 24 associated with skills and job opportunities listed on the page including but not limited to the users availability by skill, time of day, day of week. Booked jobs/shifts with skill, location and jobs/shifts applied for 56 and 60 and availability for the skills listed 60.

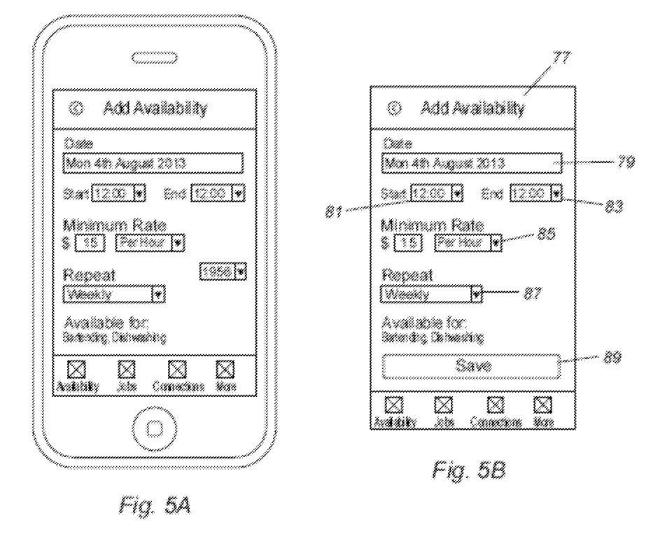

FIGS. 5A and 5B illustrate yet another preferred embodiment electronic page 77 of the invention. Specifically, the page illustrated allows subscriber users to add/edit their general availability by skill for taking on new job opportunities. For example, a subscriber user can enter the date 79, the start and ending times 81, 83, a minimum pay rate 85 and the daily, weekly, fortnightly or monthly level 87 of availability related to their ability to take on new jobs. After entering the data, the user can save 89 the information for viewing by other network connections.

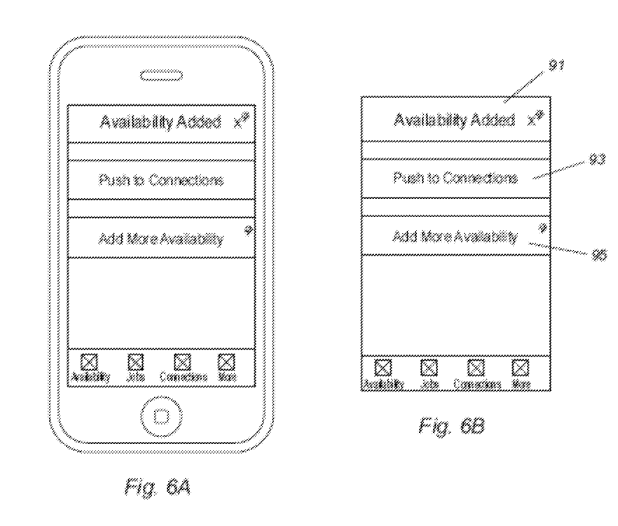

FIGS. 6A and 6B illustrate an electronic page of the invention wherein a subscriber user's availability 91 is listed and viewable by other subscriber users. Further illustrated is a button a subscriber user can select to push or forward 93 their availability to other subscriber users. The page further allows the subscriber user to add more availability 95 for other prospective job opportunities.

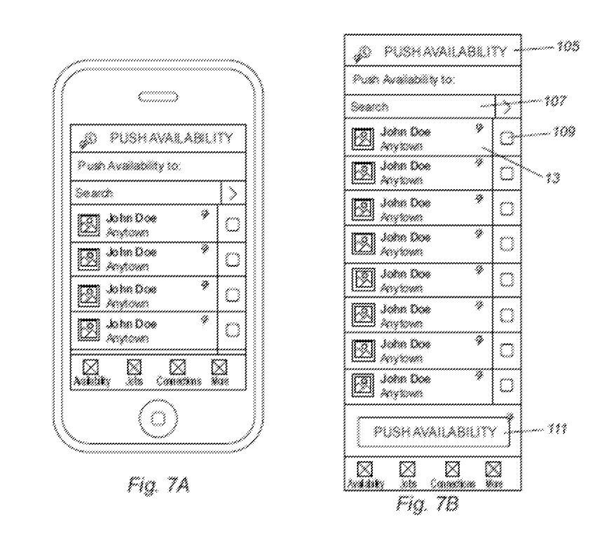

FIGS. 7A and 7B illustrate an electronic page 105 of the invention wherein a subscriber user can forward (i.e., “push”) their availability 111 for a particular job opportunity or time slot to other subscriber users 13, 109 that may have an interest in employing the subscriber user. The subscriber user can also conduct a search 107 of other subscriber users to whom they may forward or push their availability to in search of a position or job opportunity.

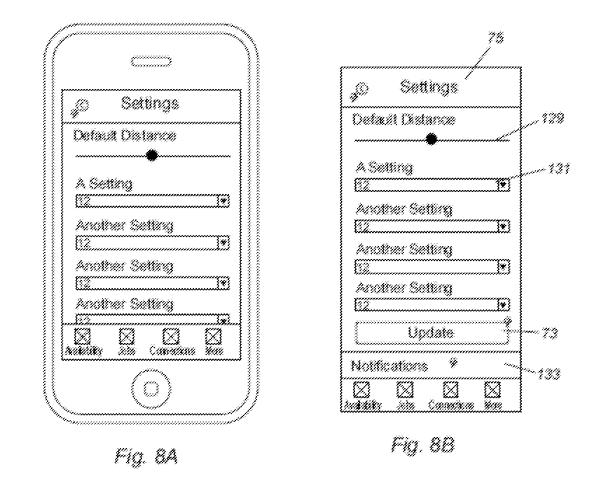

FIGS. 8A and 8B illustrate yet another preferred embodiment electronic page of the invention wherein a subscriber user can edit and add search criteria and filtering when either searching for job opportunities or in searching for qualified candidates to fill available job positions or shifts 75. For example, a subscriber user can limit the distance 129 in which they will travel to a job site or contrary wise, an employer subscriber/client user can limit the search for candidates to a certain specified distance from the work site. Other settings and search criteria 131 can be added as well and updated as appropriate 73. The subscriber user can also view notifications via email, SMS or pop up message including but not limited to availability that has been pushed to their account 133 by other subscriber users.

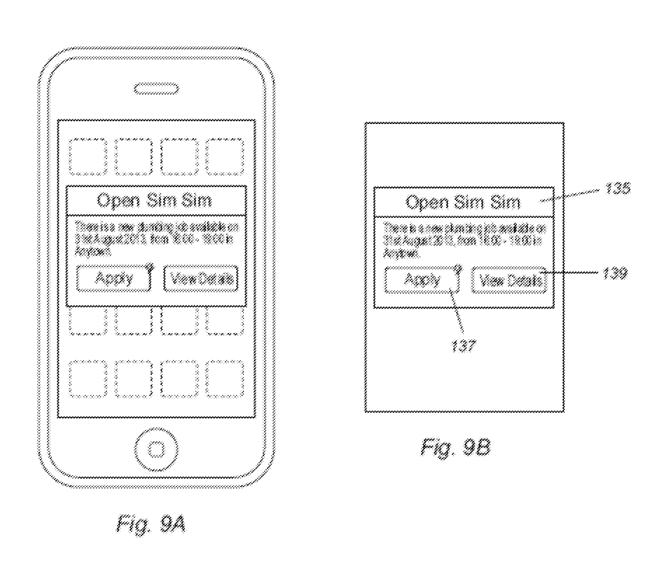

FIGS. 9A and 9B illustrate yet another preferred embodiment of an electronic page of the invention wherein a subscriber user is able to view a newly posted job opportunity via mobile device or online. More specifically, as shown, the page displays the “app” title, in this case, “Open Sim Sim” 135, and provides the subscriber user the opportunity to either select a button to view the details of the available position/job 139 or to select another button 137 to simply apply for the position/job.

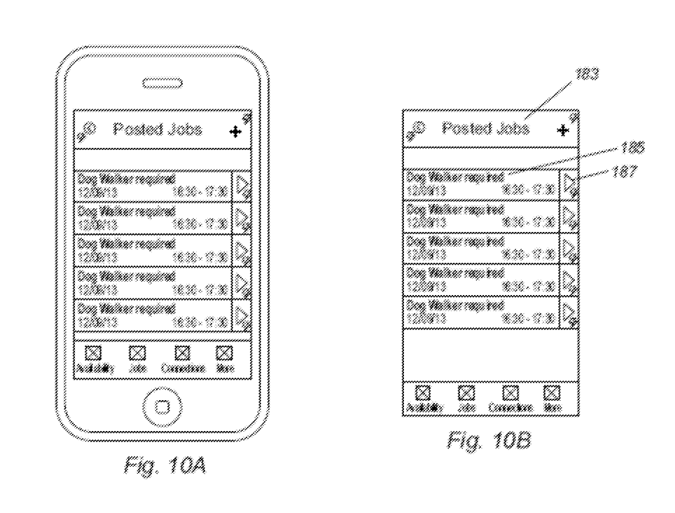

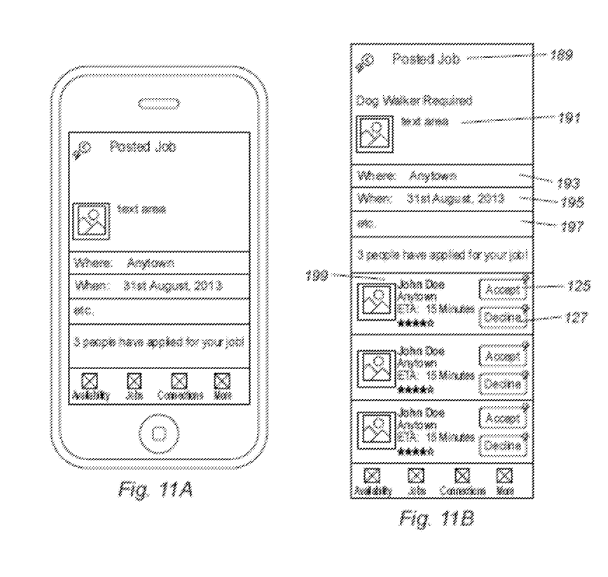

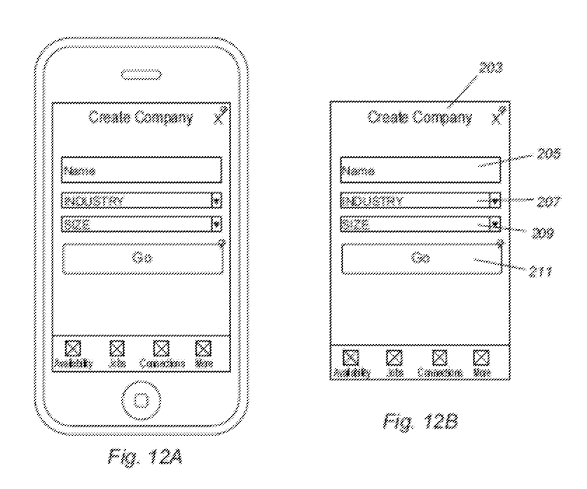

FIGS. 10A and 10B illustrate yet another preferred embodiment of the invention which displays posted positions/opportunities for viewing by a subscriber user 183. More specifically, the page displays the particular job position or opportunity 185 including date and time of the position/opportunity. In the event the subscriber user wishes to see additional details regarding the job position/opportunity, they can select the details button 187 which will display all details associated with the posted position/opportunity.

FIGS. 11A and 11B illustrate yet another preferred embodiment and version of an electronic page of the invention that displays posted jobs/opportunities 189. As shown, in the event an employer/client subscriber user receives notification that they have received interest from an employee/professional subscriber user for a new job posting, the employer/client subscriber user can view general text 191 associated with the job posting, its location 193, the dates required in order to work the job 195, the name of the employee/professional applying for the job, their location, their estimated time of arrival and their recommendations 199, and other miscellaneous information related to the position/opportunity 197. Further, the employer/client subscriber user can select either a button to accept the position 125 or ignore the position 127. The Figure also illustrates the name of the employee/professional subscriber user that is associated with the job posting 198.

FIGS. 12A and 12B illustrate yet another preferred embodiment of an electronic page of the invention as displayed on a mobile device. Specifically, the display and page allows a subscriber user to create a new corporate entity 203 on their account, further allowing the user to include name of the business 205, the industry type 207 and size of the business (employee number range) 209. The subscriber user is able to save the business information by selecting a button 211 whereupon the entered information is saved and thereafter viewable by other subscriber users.

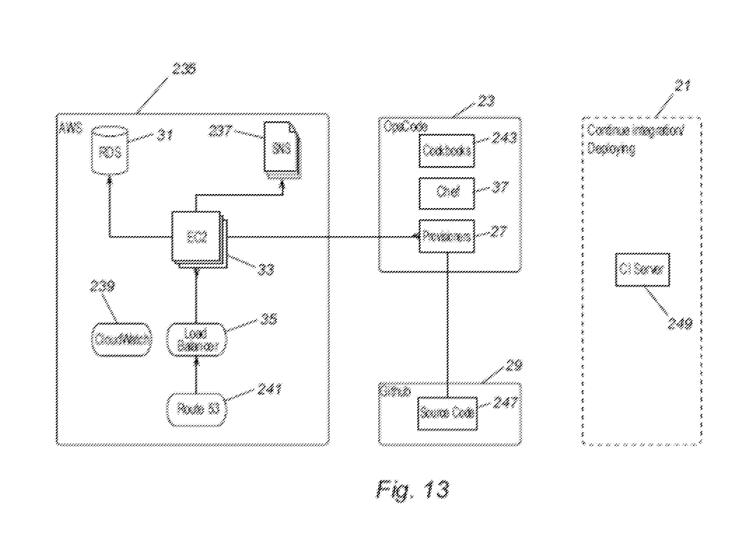

FIG. 13 depicts the hardware and software “backend” of the system application and invention claimed herein. In particular, the illustration provides 3 primary sections for backend hardware and software that include elements of the mobile device implemented system application. An Amazon Web Services environment (AWS) 235 is employed to host the system application in conjunction with an Amazon Relational Database Service (RDS) 31, Simple Notification Service (SNS) 237 to “push” notifications to subscriber users, an Amazon Elastic Compute Cloud (EC2) 33 provides resizable computing capacity in the AWS cloud. Cloud Watch 239 provides monitoring for AWS cloud resources and the applications subscriber users run on AWS.

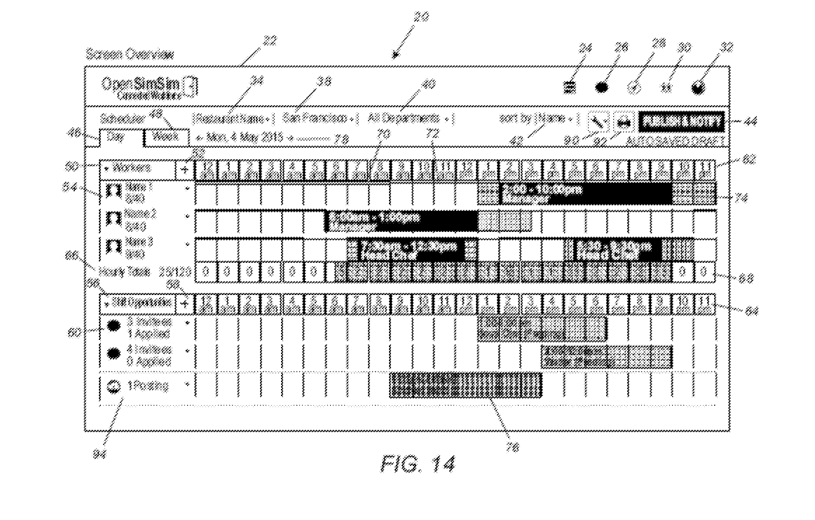

A Load Balancer 35 (Amazon Elastic Load Balancing) distributes traffic across multiple EC2 in the AWS cloud. Amazon Route 53, 241, acts as the Domain Name System (DNS) web service in the AWS cloud. OpsCode 23 provides the Chef software configuration management tool. Cookbooks 243 is an application from OpsCode and is the fundamental unit of configuration and policy distribution defining a scenario, such as for example installation and configuration of MySQL and containing all of the components required to achieve the scenario. Chef 37 from OpsCode allows for deployment of the system application software to servers and applications to any physical, virtual or cloud location. Provisioners 27 take developed code and provisions across the AWS platform. Github 29 is employed as a web-based hosting service for software development of the system application. The source code 247 is a computer program written in a high-level language that is converted to object code or machine code by a compiler. Continue integration/deploying 21 describes the element of the system application to show the continued integration and deployment of the system application “app”. The CI Server 249 is a continuous integration server that is used to automatically build and test the system application at frequent intervals. FIG. 14 illustrates a preferred embodiment of the Scheduler of the invention 20, 22. The Scheduler, shown in day mode 46, is web or mobile based and has various functionality wherein name 42, 54, employee drop down 50, day of the week 46, week 48, time 62, 64, geographical location 38 and department 40 are displayed. The Scheduler further provides time of availability 72, unavailability 70, reserved availability 76 and filled shifts 74 wherein job title and hours are displayed. Further provided are shift opportunities 56, hours of committed or actual employment to be worked 66, 68 functionality to add workers to the Scheduler 50 and an indicator relating to the number of applicants whom have applied for a particular position 60 and the number of employment positions posted 94. A functionality to add employees to the Scheduler is available 52 in addition to several digital button functionalities to establish network connections 30, prepare new Schedulers 24, opening communication 26 with network connections and logging out 32.

Reserved availability provides the ability for an employee subscriber user to create, publish and notify network connections of 44 their availability to accept new employment opportunities, including hourly shifts, temporary or permanent, at future time points, and to provide prospective and actual employers with a real-time schedule of the employee's availability and to allow those employers to reserve future dates and times for that employee for employment. By way of example, an employee subscriber user enters available time into the scheduler for a future date including hours of the day and date. The Scheduler will display the reserved availability as shown in FIG. 14 reference 76. The employee will then publish the reserved availability to his network connections with the availability also viewable by non-network connections seeking to establish new employee connections. At that point, current and prospective employers can view the reserved availability time period and choose to reserve future time within the time period for employment provided by the employee.

Variable Availability (Peak Demand Availability) is scheduled similarly wherein an employee creates and inputs a Scheduler with availability at a future date and time. With such availability, the employee stipulates a desired hourly wage into the Scheduler, above which, the employee accepts employment opportunities offered “pushed” by current and prospective employer subscriber users seeking qualified employees for work. The desired wage is displayed on a slider displayed in the Scheduler. As an employer slides the wage to increase wage, more and more employees become visible thus, increasing the employment pool available to employers willing to pay the higher desired pay rate.

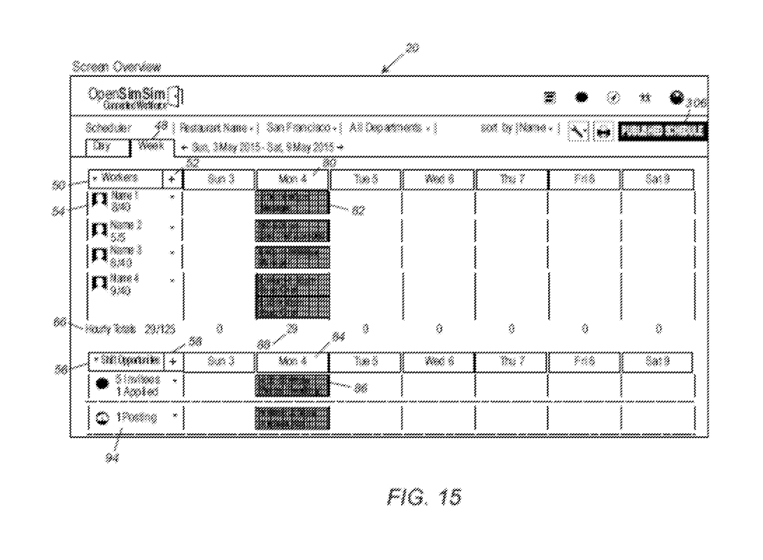

FIG. 15 depicts the Scheduler in a “week” view mode. In particular, by way of example, numerous employees 54 are displayed in addition to their respective committed work shifts 80, 82, 84 (i.e., “Monday 4”). Available positions 86 are displayed in the Scheduler indicating number of individuals to whom the position has been “pushed” and how many positions have been pushed 94. Number of total hours 88 is displayed so that employers can view how many hours they have booked and how many hours they must book with additional employees. The Scheduler is then be published and scheduled for display to network connections 306.

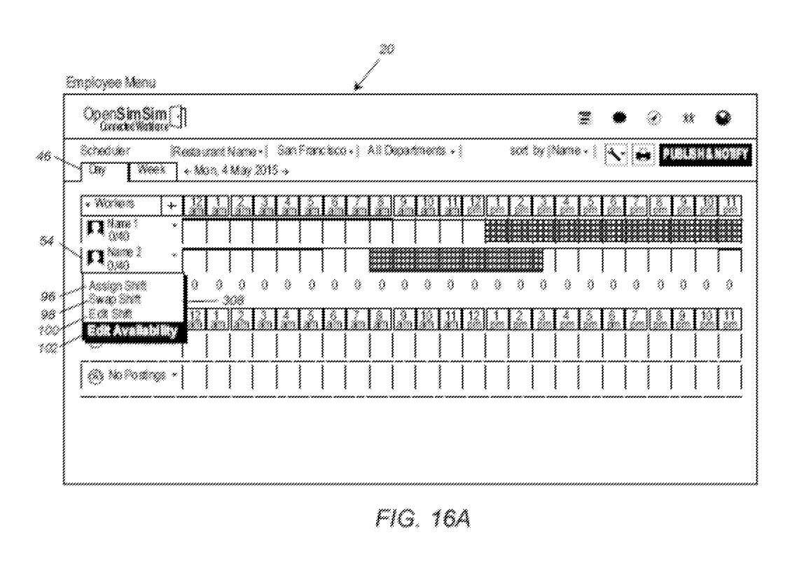

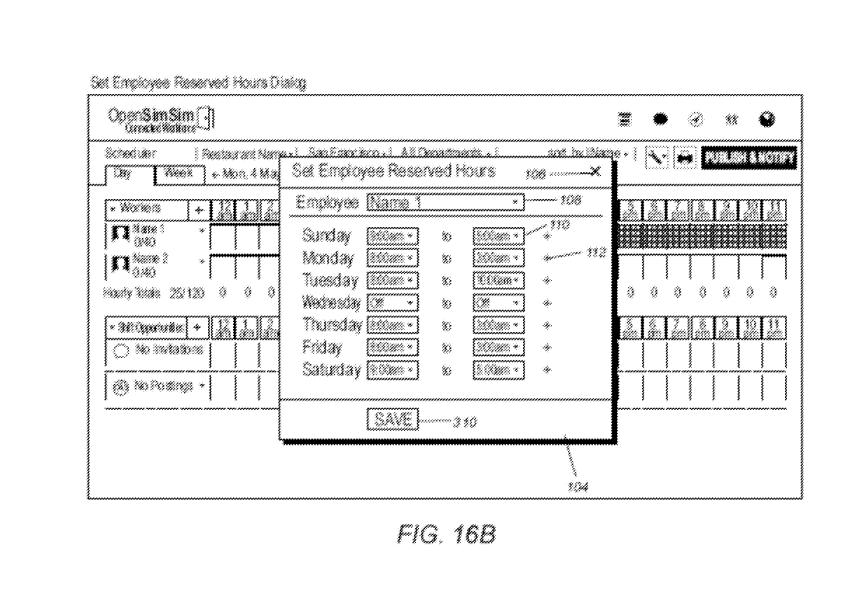

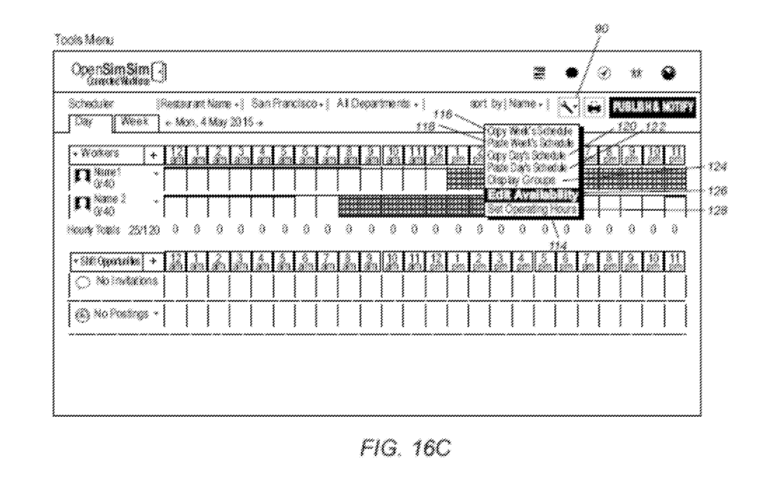

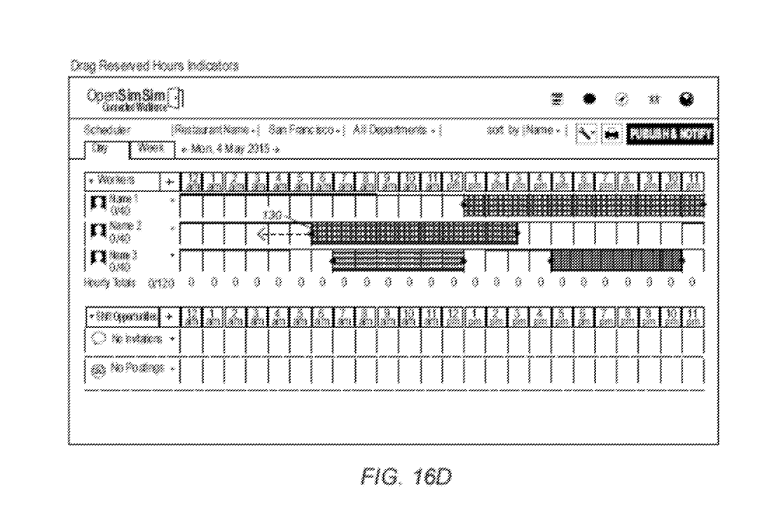

FIG. 16A depicts the Scheduler 20 in day mode. Functionality of the Scheduler includes the ability of a subscriber user to assign 96 a shift, swap a shift 98, edit a particular shift 100 and to change, edit or eliminate availability 102. FIG. 16B depicts the Scheduler and creation of reserved hours of availability for accepting employment. An employee subscriber user enters name 108 and hours of availability 110 and can add more time to his reserved availability 112 and saves the availability to the Scheduler 310. FIG. 16C depicts the Scheduler and access via the tools function 90 and creation of copied weekly or daily schedules 116, 120, pasting weekly or daily schedules 118, 122, displaying various employment opportunity groups and network connections 124 and further to edit employment availability on various existing schedules 126. FIG. 16D depicts the Scheduler of the invention wherein an employee has created reserved availability (shaded areas) with reserved hours created to include “handles” from which the employee subscriber user can slide either to increase or decrease their reserved availability in the Scheduler.

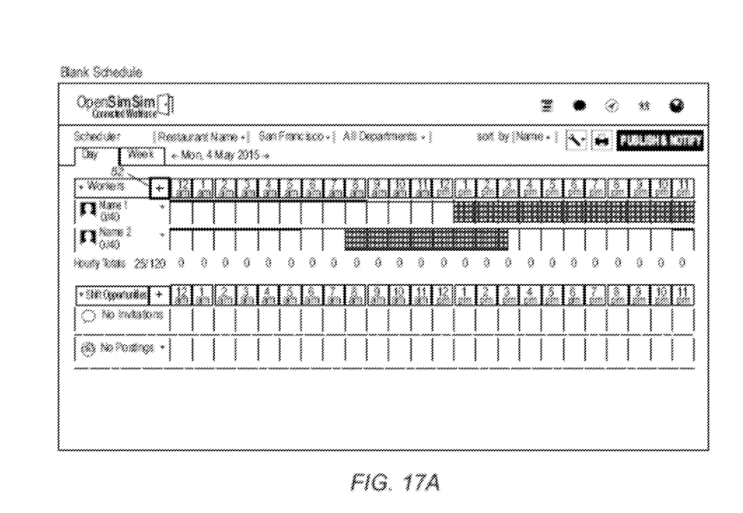

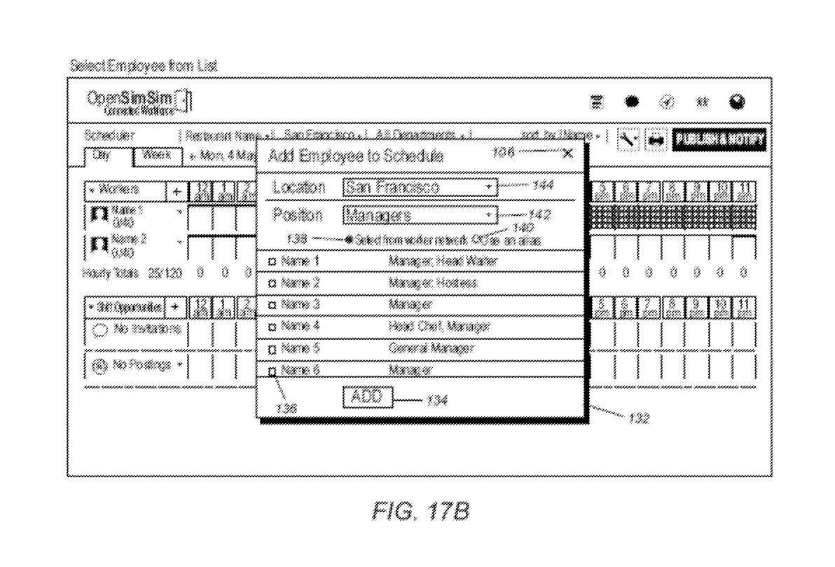

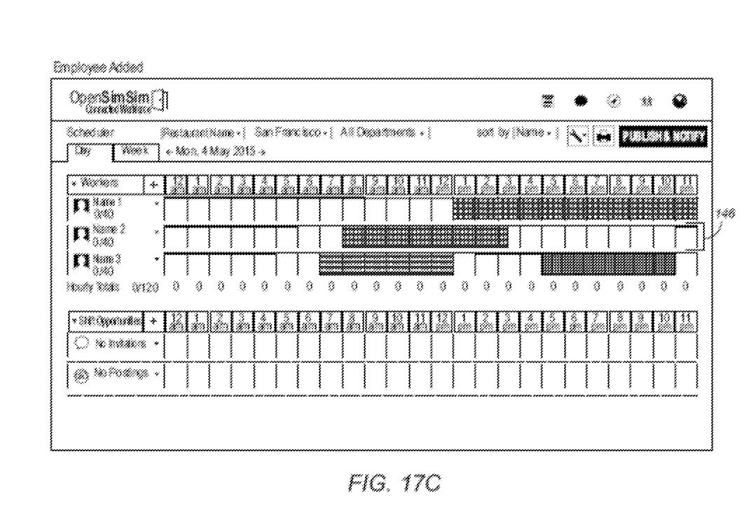

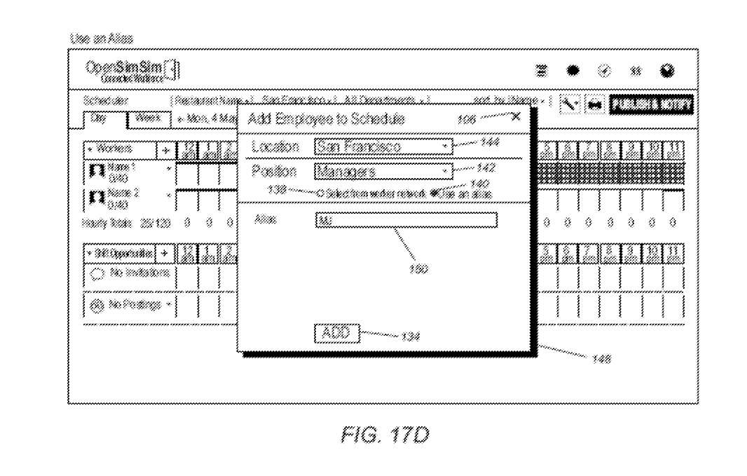

FIG. 17A depicts the Scheduler of the invention 20 in day view mode illustrating addition of employees to a particular schedule of availability 52. Employer/client subscriber users click the addition button to locate additional employee/professional subscriber users whom can accept available employment opportunities. FIG. 17B depicts a menu within the worker addition button wherein particular criteria is entered including, but not limited to, geographical location 144, name 136, job title 142 and whether such additional workers are to be selected from within the user's network connections or workers identified under an alias 140. Workers are added 134 and menu window closed to save changes 106. FIG. 17C illustrates reserved availability, availability and unavailability. In particular, shaded areas 146 represent reserved availability time periods and dates in which an added employee/professional subscriber user has assigned reserved availability in which employers/client subscriber users, identified by alias, within the employee's network connections, can reserve time periods in which to hire the employee for employment opportunities including hourly shifts, at some future time point. FIG. 17D depicts the Scheduler wherein the particulars of an employee alias to be added to the Scheduler are provided. Geographical location 144, job title 142 and alias identifier 150 are input and alias are also added to the Scheduler.

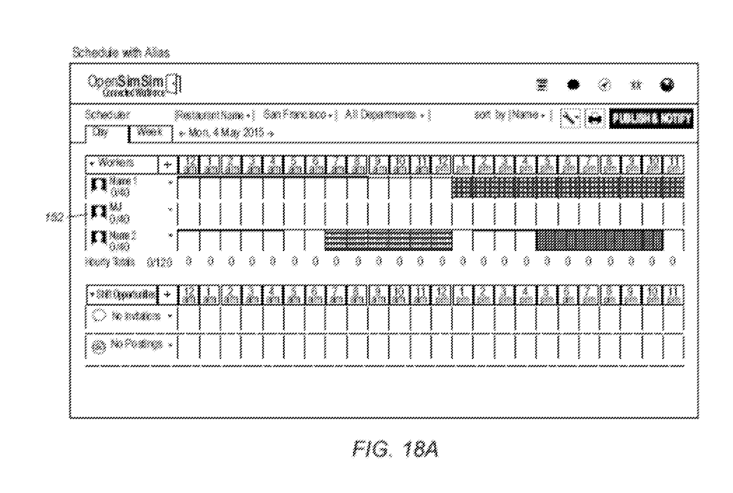

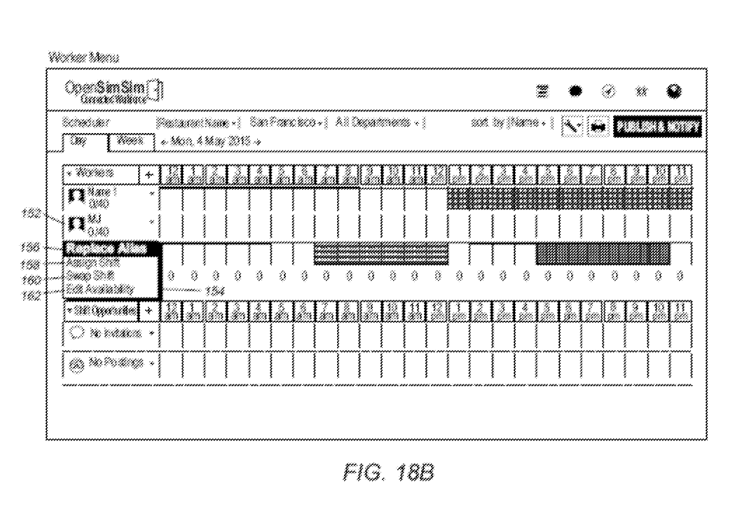

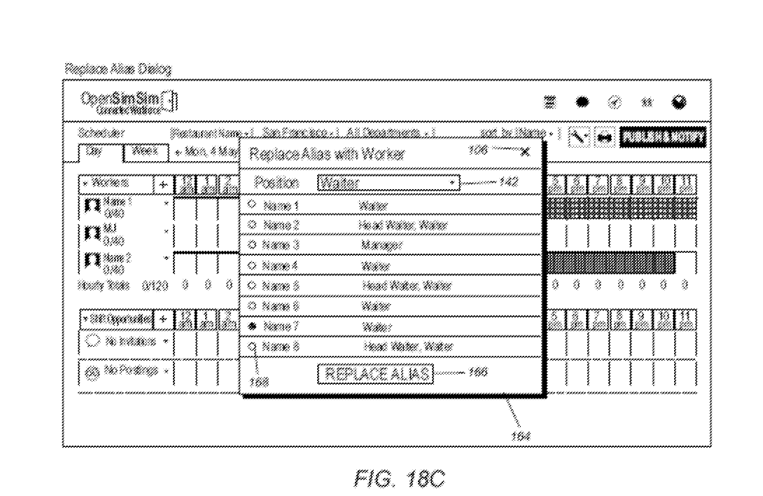

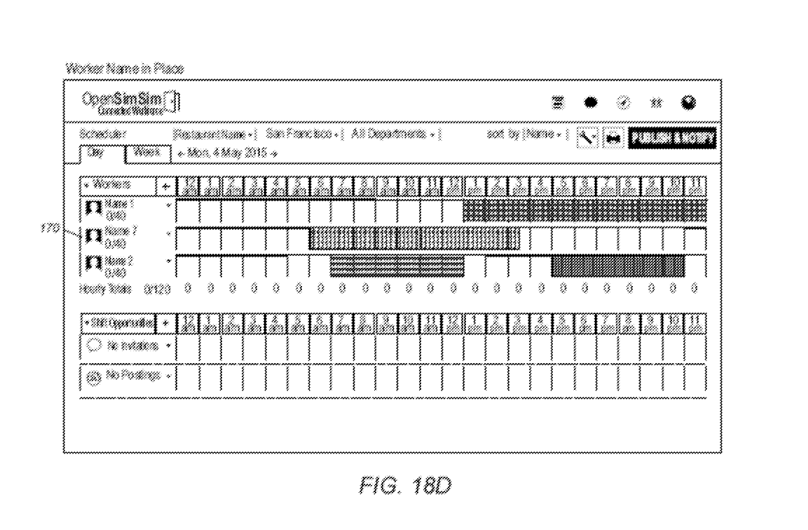

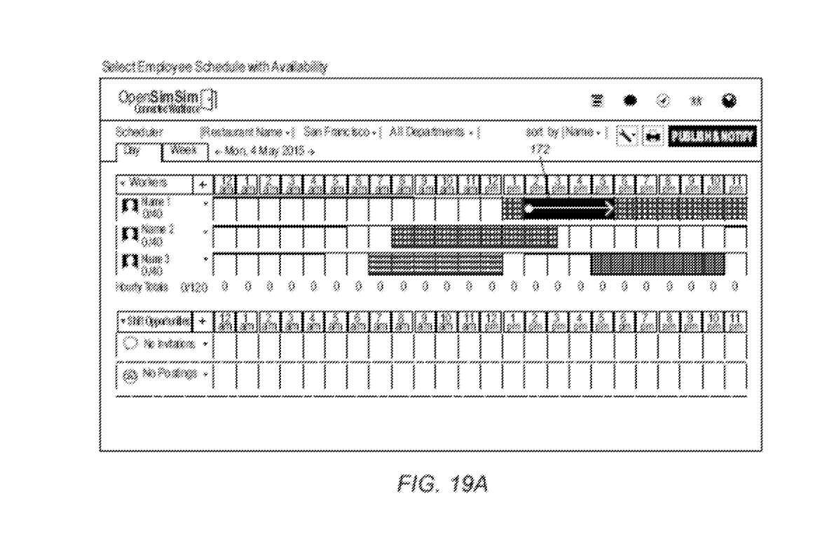

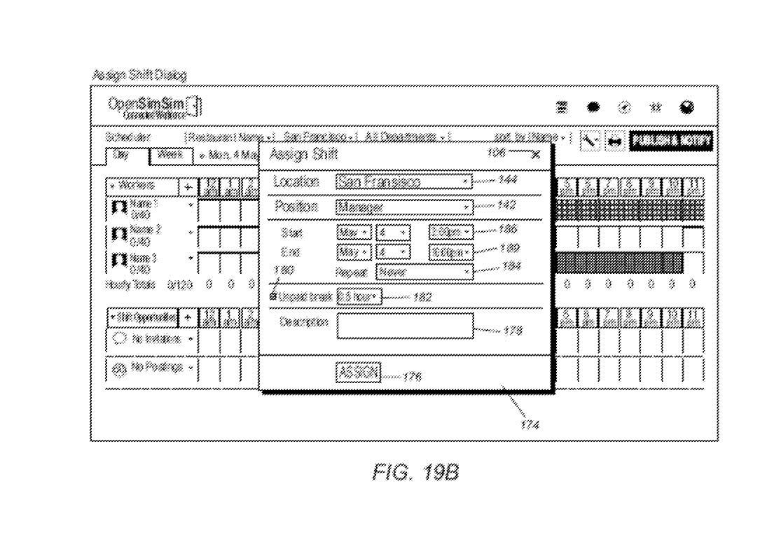

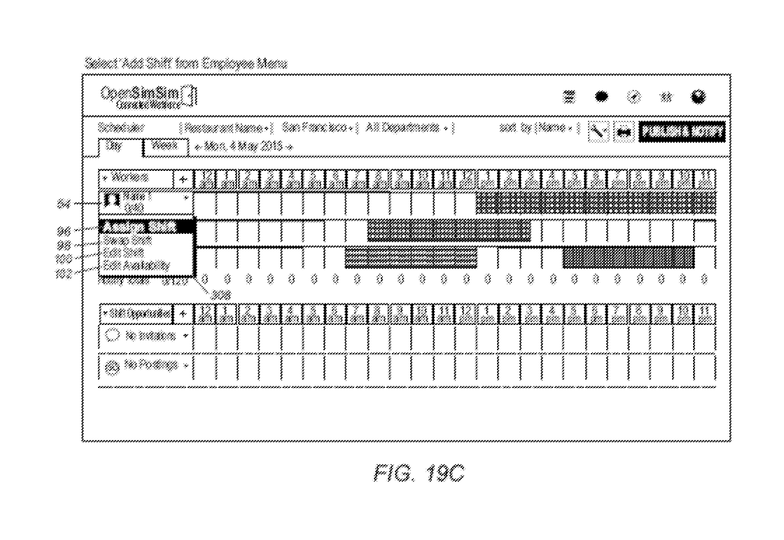

FIG. 18A depicts the Scheduler wherein the alias has been added to the Scheduler 152. Reserved availability, availability and unavailability are shown in the Scheduler, with reserved availability denoted in the shaded areas. FIG. 18B depicts the Scheduler in which an employee alias 152 is replaced 156 by another, a shift can be assigned 158 or swapped 160 and availability changed or edited 162. FIG. 18C depicts replacement of an alias employee 164 and includes input of job title 142, name 168, and a button to execute replacement 166. FIG. 18D depicts the Scheduler following replacement of an employee alias wherein the replacement alias 170 occupies the schedule.

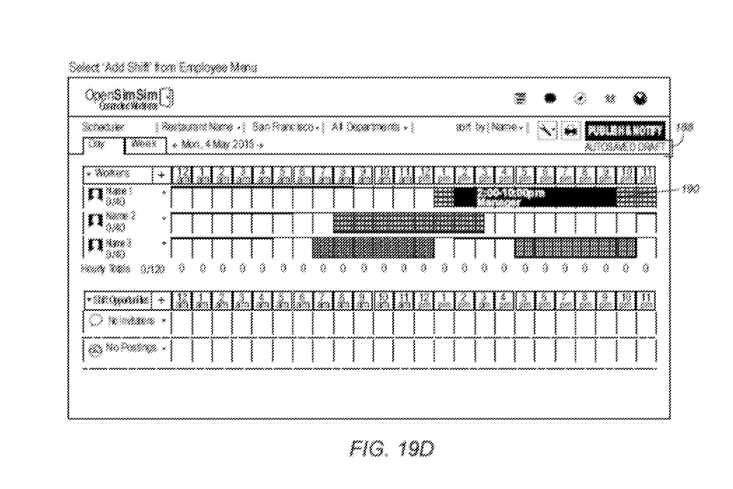

FIG. 19A depicts a Scheduler wherein a shift is created based on the availability preferences of an employee/professional subscriber user. In particular, a subscriber user (i.e., “Name 1”) inputs reserved availability (shaded areas), availability (i.e., 9 a.m. to 11 p.m.), unavailability (i.e., 12 a.m. to 9 a.m.) and committed, filled shifts. As shown, an employee/client subscriber user engages a slider 172 across available/reserved availability time periods and engages the slider over the desired time for an employment shift. FIG. 19B depicts the Scheduler wherein particular details of a shift are created and assigned 174. Details including geographical location 144, job title 142, date and times for the work shift 186, 189 and frequency of employment are available for input. In addition, details such as break periods 182, whether paid or unpaid 180, and description of responsibilities 176 are provided. Selecting “Assign” will save and create the shift and transfer the assigned shift to the current Scheduler. FIG. 19C depicts how shifts are swapped with other network connections 98, edited 100 and assigned 96 with changes saved to the current Scheduler for a particular employee 54. FIG. 19D illustrates a Scheduler following creation and assignment of a new draft schedule 188. As shown, a filled shift 190 has been added to the Scheduler for a particular employee. (i.e., “Name 1”)

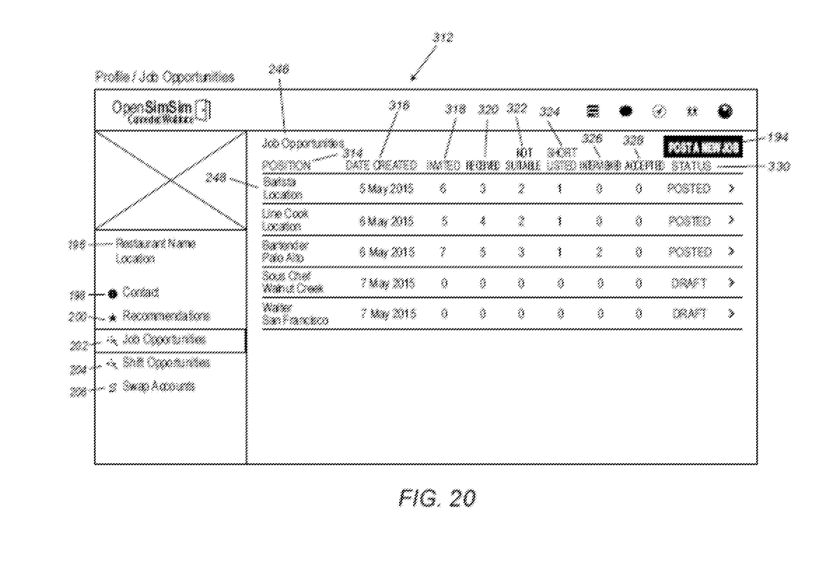

FIG. 20 illustrates the system platform wherein a listing of available job opportunities 202 are provided for viewing by prospective employee/professional subscriber users 312. Job opportunities can be selected from the navigation area (as shown, left side) within the business profiled provided. A list of current job opportunities displays information about each particular job including job title 248, 314, date on which the posting was created 316, network connections with whom the position have been invited to view the position 318, the number of prospects whom have received the job posting 320, business name 196, employees interviewed 326, employees whom have accepted a position 328 and overall status of the position 330. Employer/client subscriber users have the option of creating and posting a new job opportunity 194 based on their current needs. Additional menu items are also available to subscriber users to provide information regarding the current job position or other job opportunities 198, 200, 202, 204, 206.

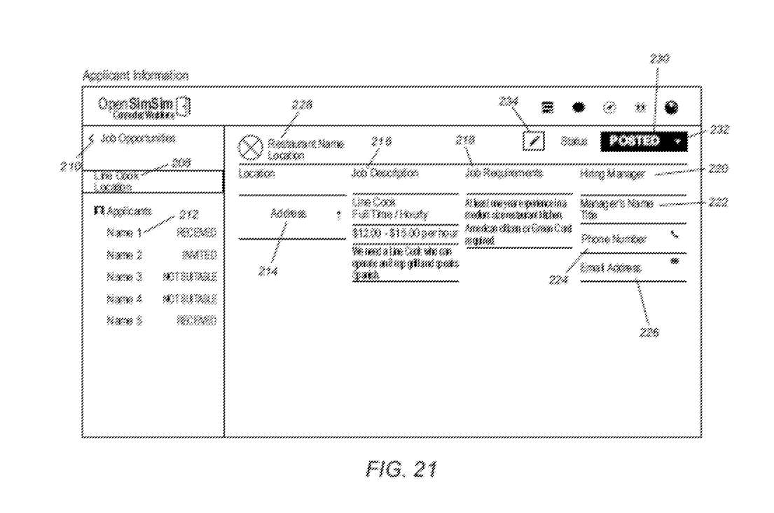

FIG. 21 illustrates the job opportunities elements of the system platform wherein the details of a particular position are displayed for prospective employee/professional subscriber users 210. Information and details including business name 228, address of business 214, job title 208, job requirements 218, phone and other contact information 224, email address 226, name and title of hiring manager 220, 222 and name of applicants for the job opportunity 212 are input and displayed. The job opportunities also provide status of the position 230, 232 and the ability to correspond with the employer directly via email 234.

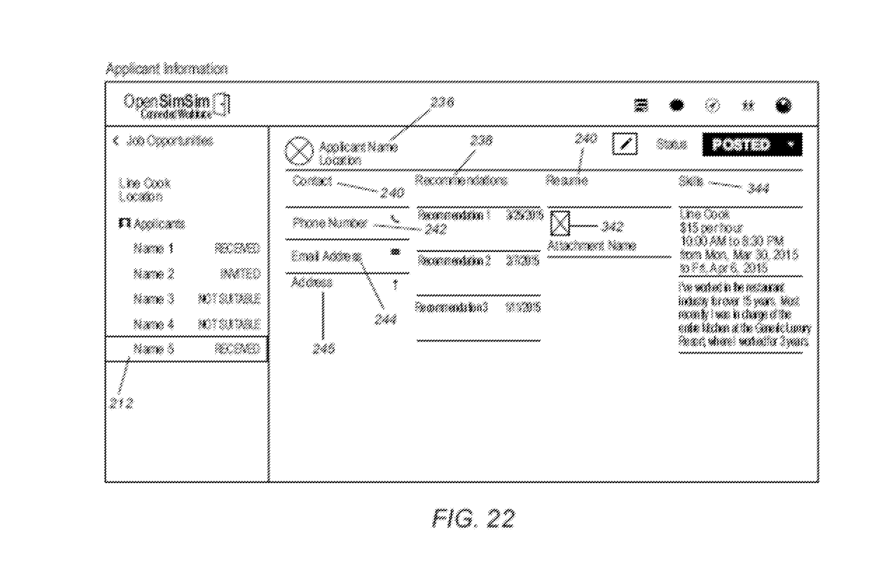

FIG. 22 illustrates the system platform of the invention wherein details of an application for employment are created and displayed. Applicant details include name 212, 236, resume 240, 342, skills 344, any attachments including cover letter for example, phone number 242, email 244 and mailing address 245.

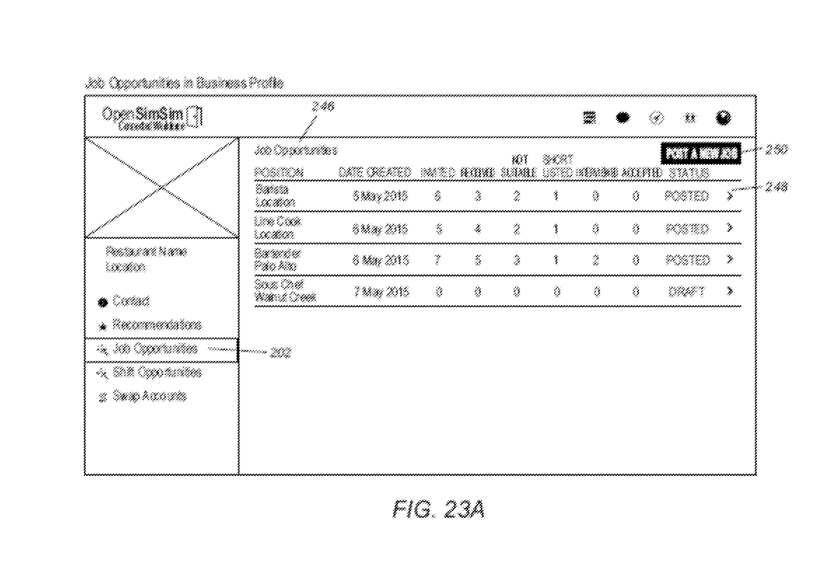

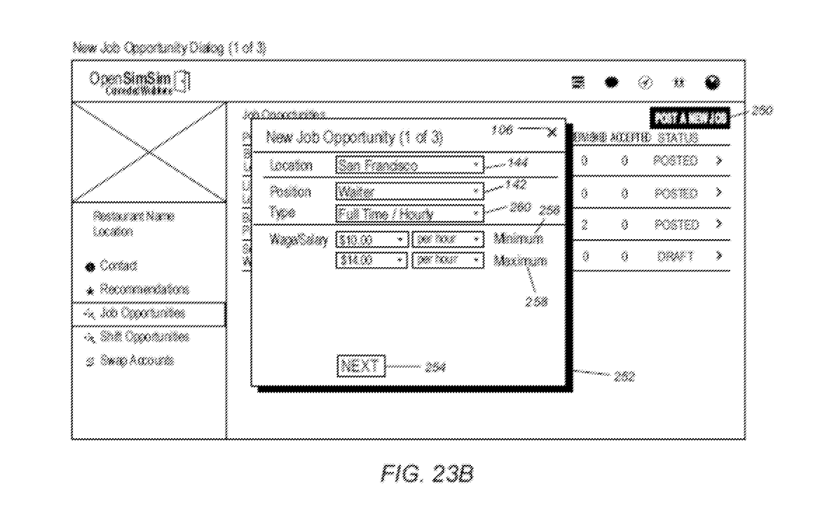

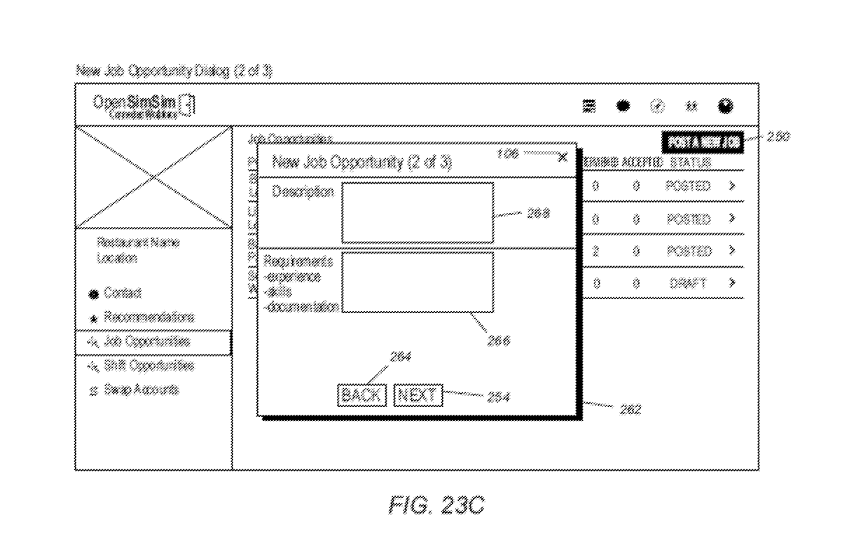

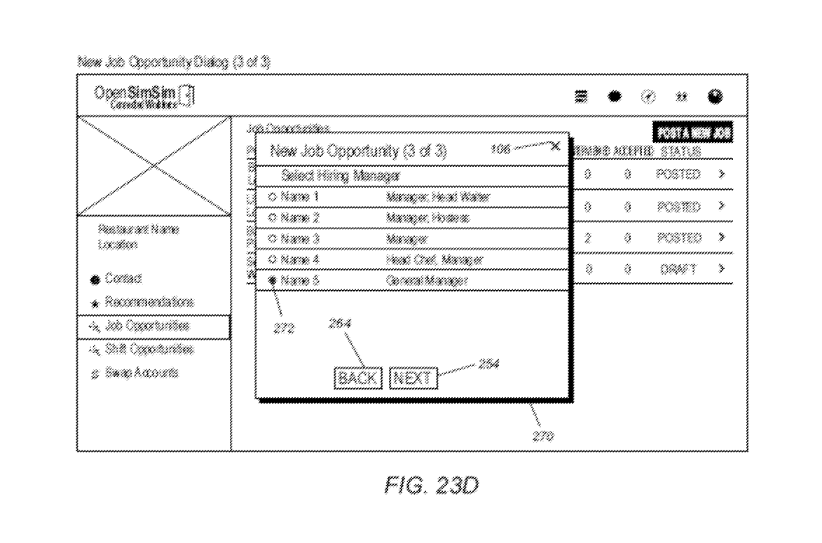

FIG. 23A illustrates details of creation of a job opportunity on the system platform. The Job Opportunities menu 202 is selected bringing up a job opportunities listing 246, 248. A button allows creation of a new job opportunity 250. When the button is selected (FIG. 23B), a menu 252 opens wherein specifics regarding the new position are input including, for example, geographical location 144, job title 142, hours 260 and hourly wage 258. A “Next” button 254 advances the menu to input additional details regarding the job opportunity. FIG. 23C illustrates a menu page in which a written job description is input 268 and job qualifications including references is requested 266. Users advance the job opportunity 254 or go back to edit 264. FIG. 23D illustrates further details menu 270 that are input for the newly created job opportunity including name of the hiring manager 272, hiring manager job title and the like.

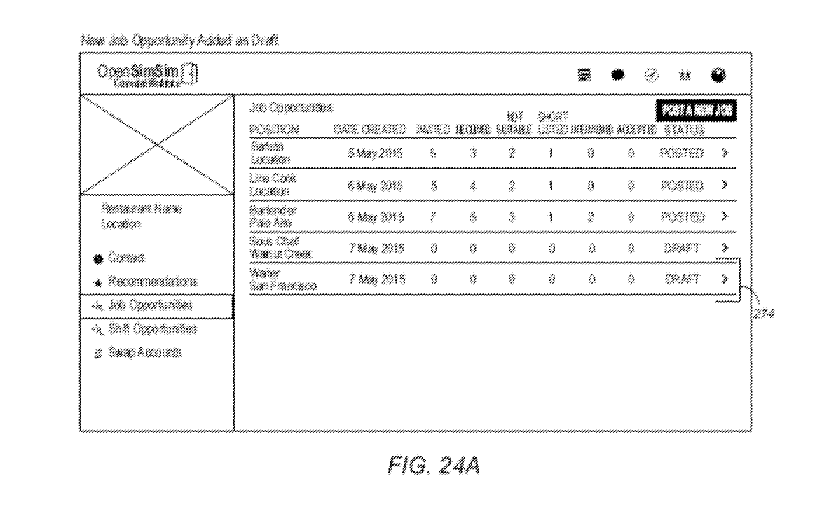

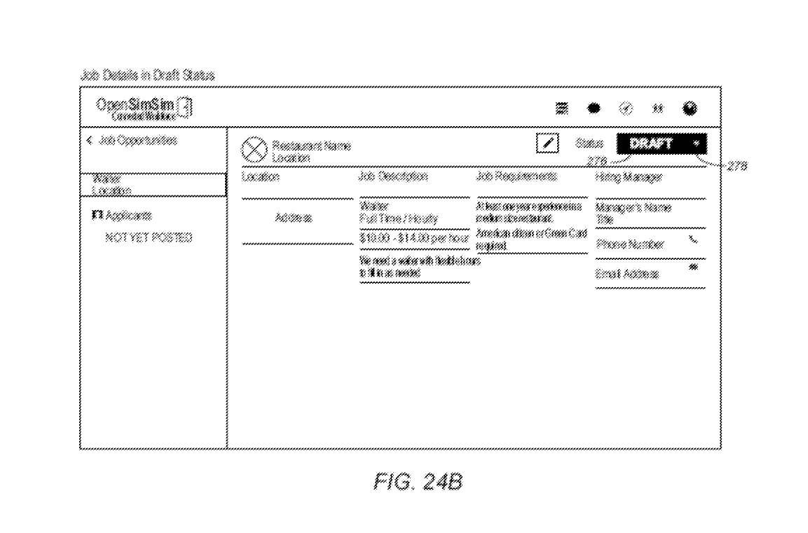

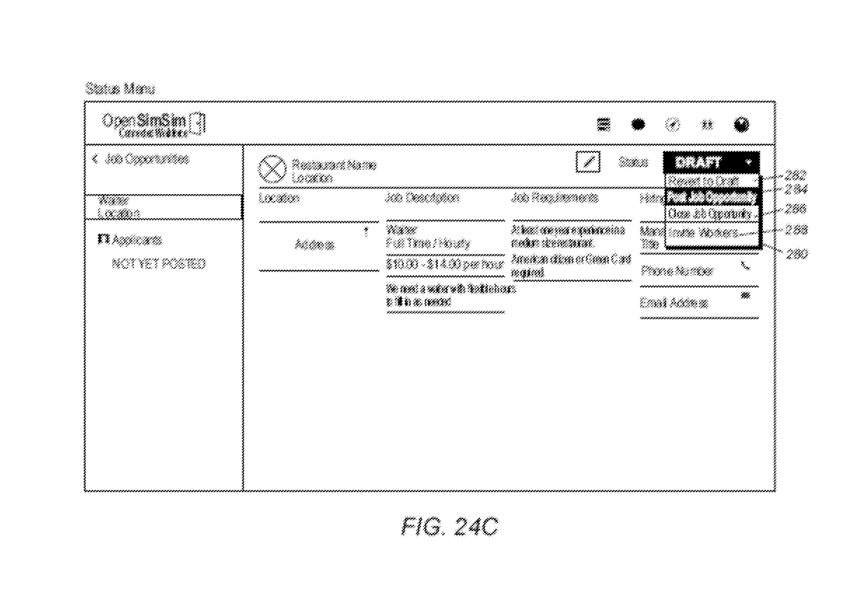

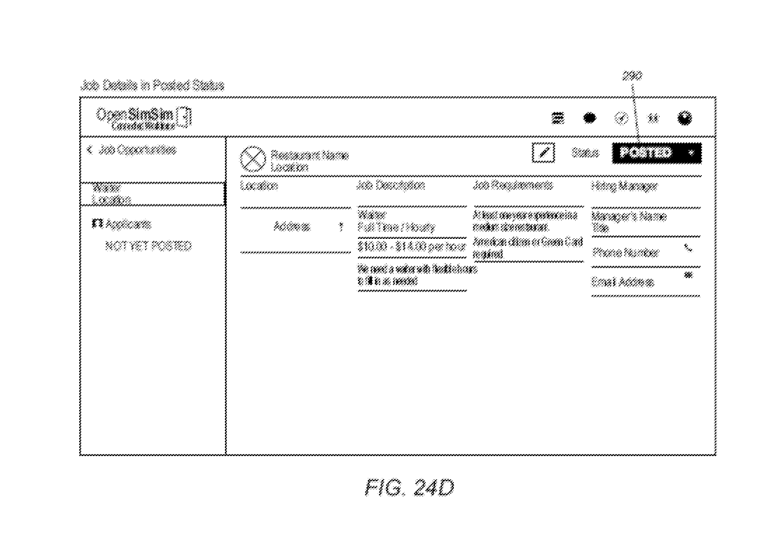

FIG. 24A depicts the job opportunities section of the system platform wherein newly created job opportunities are posted for viewing by prospective employee/professional subscriber users. As shown, newly created but not yet published positions are presented to the job opportunities creator in “draft” form 274. The job details page displays the information provided for the particular job positing created. With draft postings there are no applicants listed since the job opportunity has not yet been published and posted. Prior to publication and posting, job opportunities are displayed in “Draft” form 276, 278. FIG. 24C illustrates options to a job opportunity creator with regard to the posting. For example, a job creator can post the new position 284, edit an existing posting by reverting it to draft form 282, closing the job opportunity 286 or inviting employee/professional subscriber users whom are network connections of the job creator 288 to apply for the position. FIG. 24D illustrates a job opportunity in a “posted” status.

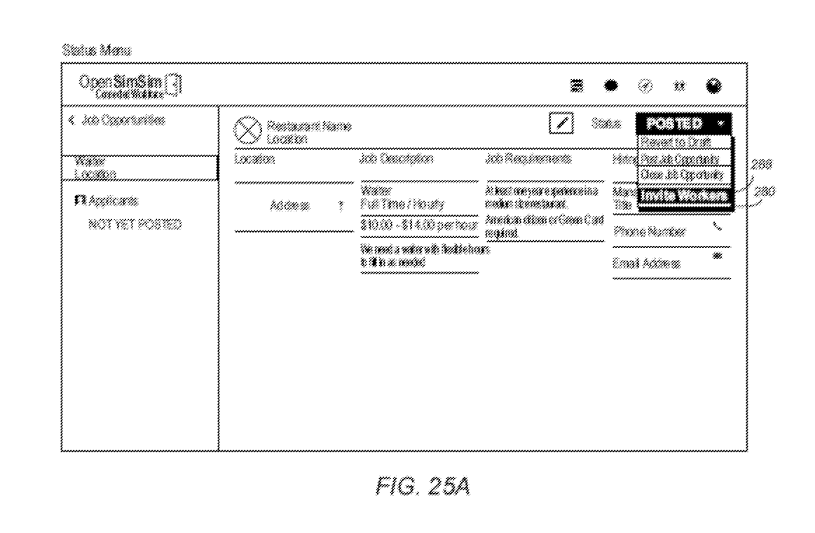

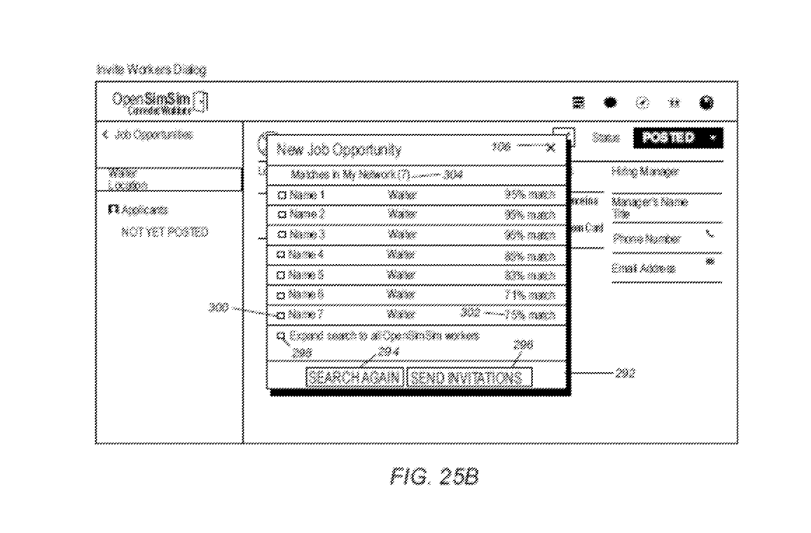

FIG. 25A illustrates a preferred embodiment of the invention wherein employer/client subscriber users invite employees to apply for newly created job postings (i.e., invitations are “pushed” to employee/professional subscriber users of interest). As shown, a pull down menu allows a user to select “invite workers” wherein the details of the job opportunity are “pushed” to desired employees 288, 280. FIG. 25B depicts a menu generated 292 to invite prospective employees for a posted position. In particular, a search button 294 provides employers with a listing of the names 300 of prospective employees within the employer's network connections and “matches” 304 those whom possess desired skills that fulfill the requirements of the position 302. Employers have the option of selecting particular employees and sending (i.e., “pushing) those individuals invitations to apply for the open position 296. The system job invitation page also provides a percentage match indicating the degree to which the skills and experience of the individual match the criteria sought for the position 302.

The system application API 256 is the system application-programming interface, which consists of a set of routines, protocols and tools. Apache2 257 is an HTTP Web Server while the Nginx (proxy) 258 is a Proxy Server. The System application Front-end mobile layer 259 enables subscriber users to interact with the system application via their mobile device. Phonegap 260 is the mobile development framework produced by Nitobi, purchased by Adobe Systems. It enables software programmers to build applications for mobile devices using JavaScript, HTML5, and CSS3, instead of device-specific languages such as Objective-C or Java. The system application Front-end desktop layer 261 enables subscriber users to interact with the system application via their desktop computer. Javascript 262 is employed as an object-oriented computer programming language commonly used to create interactive effects within web browsers. Ember 264 and Ember data 263 provides a real web app framework with the ability to build the system application as a one-page app (without refreshing or opening a new page when a subscriber user navigates through the system application. All transactions and API calls are with one page. When the Ember application is finished, it is ported to a Phonegap to deliver a cross platform mobile application.

In a preferred embodiment of the invention subscriber users will occupy the designation of either Employee subscriber user, Employer subscriber user, Professional subscriber user, Client subscriber user or all of the above. The illustrations and descriptions herein are not intended to limit the scope of the invention to merely the elements provided. It will be understood by one of pertinent skill in the art that other functionalities (i.e., search engine, display features, etc.) are envisioned and within the scope of the invention. A rating system is also employed by subscriber users. The rating system permits users the ability to provide written recommendations for services provided for each skill. Subscriber users will be notified when a recommendation is written and users will be able to delete the recommendation if desired.

In another preferred embodiment, the search engine of the invention employs use of a database on a network server that stores and saves the background and professional qualifications, business information and other attributes pertinent to the subscriber users associated with the mobile device implemented substitute fulfillment system and social networking application (“app”). As envisioned herein, the social networking application employs use of network processors that accurately and automatically match job postings created by employer/client subscriber users to the background and qualifications of employee/professional subscriber users whom may be aware or unaware of the available job posting.

The system and methods herein also employ non-automated matching between job and job qualifications posted to the system by an employer/client subscriber user and an employee/professional subscriber user possessing desired skills as outlined in the job posting description. The non-automated process includes for example, review of one or more job opportunities posted by an employer/client subscriber user on the system, the posting outlining details and desired job qualifications necessary for the position

To prepare the “app” or application for mobile device, methods as are known in the art are generally employed and include creation of a network server capable of saving background information on subscriber users, companies and job descriptions. The communication link of the network server encompasses internet or mobile device connections including for example Wi-Fi connectivity. The invention employs use of the network server to receive job postings and employment opportunities, permanent as well as temporary, posted by employer/client subscriber users and make the job postings and employment opportunities viewable on a mobile device “app” or internet interface via website.

Likewise, creation of the web based, online version of the system and methods employ traditional methods of web based design as are generally known in the art.

Certain advantages can be obtained in utilizing the present invention. Foremost, the invention allows a subscriber user the ability to efficiently and accurately push their real time availability by skill set and review available job opportunities that fit his or her professional qualifications and skill set conveniently from any smart phone or mobile device, as well as online via the internet.

Although the invention has been described with reference to the above examples, it will be understood that modifications and variations are encompassed within the spirit and scope of the invention. Accordingly, the invention is limited only by the following claims

What is claimed is:

1. A method of staffing available employment shift opportunities comprising;
identifying a plurality of members of a web and mobile-based implemented job placement recruitment system, social networking application (“app”), each of the plurality of members having a member profile;
wherein the web and mobile-based implemented job placement recruitment system, social networking application comprises a computer processor and database;
wherein each of the plurality of members can establish network connections with one another;
identifying a plurality of employee subscriber users from the plurality of members to staff the available employment shift opportunities by means of a candidate search and search engine;
identifying qualified employee subscriber users from the plurality of members relative to one another based on particular skills, experience levels, experience hours and availabilities for short or long term job placement for the available employment shift opportunities;
generating a scheduler of availability for each qualified individual employee subscriber user to be viewed by an individual employer subscriber user wherein the scheduler is generated when an individual employee subscriber user inputs time and days into the scheduler on which the individual employee subscriber is available and unavailable to accept employment opportunities;
displaying and publishing the time and days in the scheduler on the web and mobile-based implemented job placement recruitment system, social networking application (“app”), the time and days comprising availability information;
generating the availability information based on information gathered by means of an internet source and geolocation of each qualified individual employee subscriber user;
searching the availability information of the plurality of the qualified employee subscriber users by means of the search engine;
generating a work history of each of the qualified individual employee subscriber users including the experience hours worked by means of geolocation;
the individual employer subscriber user hiring an appropriately qualified individual employee subscriber user to staff the employment shift based on the qualified individual employee subscriber user's experience hours;
depublishing the availability information corresponding to the qualified individual employee subscriber user at the moment the individual employer subscriber user hires the qualified individual employee subscriber user;
the qualified individual employee subscriber user generating new experience hours by activating the web and mobile-based implemented job placement recruitment system, social networking application (“app”) at the beginning of a work shift and deactivating at the end of the work shift;
storing the generated experience hours on qualified individual employee subscriber user's member profile so that the experience hours are tallied for the qualified individual employee subscriber user and added to the qualified individual employee subscriber user's member profile so that it is viewable by future prospective employer subscriber users.

2. The method of claim 1 wherein the availability information comprises availability, unavailability, peak demand availability or reserved availability periods of time.

3. The method of claim 1 wherein the internet source is Google® Popular Times

4. The method of claim 3, wherein the experience hours are displayed in a search results list generated following the search of the availability information of each of the plurality of qualified employee subscriber users.

5. The method of claim 4, wherein the individual employer subscriber user hires the qualified individual employee subscriber user whom possesses a minimum number of qualifying experience hours.

6. The method of claim 1, wherein generating the scheduler comprises: an individual employee subscriber user inputting time and days into the scheduler on which the individual employee subscriber user is unavailable to accept the employment opportunity below a desired rate of pay, but is available to accept the employment opportunity at or above the desired rate of pay, wherein the individual employer subscriber user hires the qualified individual employee subscriber user during an available period of time on the scheduler by offering a pay rate at or above the desired rate of pay, once offer is tendered, the scheduler depublishes the availability information corresponding to the period of time hired.

7. The method of claim 6 wherein the period of time comprises the individual employee subscriber user's peak demand availability.

8. The method of claim 7 wherein generating the scheduler further comprises;
the individual employer subscriber user conducting the search of the plurality of qualified employee subscriber users by engaging a slider, wherein the individual employer subscriber user conducts the search by including varying rates of pay in search criteria by adjusting the slider upward or downward to correspond with increasing or decreasing rates of pay to be offered,
generating a search results list of a qualified pool of qualified employee subscriber users whose minimum pay rate for acceptance of employment is met by the rate offered by the individual employer subscriber user engaging the slider;
hiring a particular qualified employee subscriber whose minimum pay rate for acceptance of employment is met.

9. The method of claim 8 wherein the web and mobile-based implemented job placement recruitment system hires the qualified individual employee subscriber user automatically based on the experience hours of the qualified individual employee subscriber user.

10. The method of claim 9 wherein the scheduler creates a two-sided network of connections.

11. A method of staffing available employment shift opportunities comprising;
a web and mobile-based implemented job placement recruitment system, social networking application (“app”), the method comprising a plurality of members having a member profile, each member comprising either an employee subscriber user or an employer subscriber user;
wherein the web and mobile-based implemented job placement recruitment system, social networking application comprises a computer processor and database;
a qualified individual employee subscriber user identifying a plurality of available employment shift opportunities with a search engine, the available employment shift opportunities identified by means of an internet source and geolocation;
an individual employer subscriber user identifying a plurality of qualified employee subscriber users whom are seeking short or long term employment opportunities with the search engine;
notifying the qualified individual employee subscriber user of the existence of the available employment shift opportunities wherein the qualified individual employee subscriber user meets the qualifications of the available employment opportunity, wherein the qualified individual employee subscriber user was previously employed by the individual employer subscriber user but is no longer employed as such;
notifying the individual employer subscriber user of the availability of the qualified individual employee subscriber user to accept the available employment shift opportunity;
generating a scheduler of availability associated with the qualified individual employee subscriber user to be viewed by the individual employer subscriber user wherein the scheduler is generated when the qualified individual employee subscriber user inputs time and days into the scheduler on which the qualified individual employee subscriber is available and unavailable to accept employment opportunities;
the web and mobile-based implemented job placement recruitment system, social networking application displaying and publishing the time and days in the scheduler, the time and days comprising availability information,
generating the availability information based on information gathered by means of an internet source and geolocation;
the individual employer subscriber user hiring the qualified individual employee subscriber user to staff the available employment shift opportunity based on the qualified individual employee subscriber user's historical connection to the individual employer subscriber user;
the qualified individual employee subscriber user generating experience hours when the qualified individual employee subscriber user activates the web and mobile-based implemented job placement recruitment system, social networking application (“app”) at the beginning of a work shift and deactivating at the end of the shift;
storing the generated experience hours on the qualified individual employee subscriber user's member profile so that the experience hours are tallied and added to the qualified individual employee subscriber user's member profile so that it is viewable by prospective employer subscriber users.

12. The method of claim 11 wherein the availability information comprises availability, unavailability, peak demand availability or reserved availability periods of time.

13. The method of claim 11, wherein experience hours comprise the number of hours the qualified individual employee subscriber user has worked for a particular employer subscriber user.

14. The method of claim 13, wherein the experience hours are displayed in a search results list generated following the search of the availability information of each of the plurality of qualified employee subscriber users.

15. The method of claim 14, wherein the individual employer subscriber user hires the qualified individual employee subscriber user whom possesses a historical connection to the individual employer subscriber user and whom possesses a minimum number of qualifying experience hours.

16. The method of claim 11 wherein the internet source is Google® Popular Times

17. The method of claim 16 wherein the period of time comprises the individual employee subscriber user's peak demand availability.

18. The method of claim 17 wherein generating the scheduler further comprises, the individual employer subscriber user conducting the search of the plurality of qualified employee subscriber users by engaging a slider, wherein the individual employer subscriber user conducts the search by including varying rates of pay in search criteria by adjusting the slider upward or downward to correspond with increasing or decreasing rates of pay to be offered, generating a search results list of a qualified pool of skilled employee subscriber users whose minimum pay rate for acceptance of employment is met by the rate offered by the particular employer subscriber user engaging the slider.

19. The method of claim 18 wherein the web and mobile-based implemented job placement recruitment system, social networking application hires the qualified individual employee subscriber user automatically based on the experience hours and historical connection of the individual employee subscriber user in relation to the individual employer subscriber user.

20. The method of claim 11 wherein the scheduler creates a two-sided network of connections.

21. A method of optimizing employer staffing comprising;
an individual employer subscriber user accessing a web and mobile-based implemented job placement recruitment system, social networking application (“app”);
wherein the web and mobile-based implemented job placement recruitment system, social networking application comprises a computer processor and database;
the web and mobile-based implemented job placement recruitment system, social networking application accessing peak and non-peak business days and times by means of an internet source and geolocation;
displaying the peak and non-peak business days and times on a web and mobile-based implemented job placement recruitment system, social networking application (“app”) interface;
displaying a shift schedule prepared by an employer subscriber user on the web and mobile-based implemented job placement recruitment system, social networking application (“app”) interface;
overlaying the peak and non-peak business days and times onto the shift schedule so that the employer subscriber user can view the data points simultaneously;
the employer subscriber user assessing its staffing needs based on the graphical overlay and determining if staffing is sufficient;
the employee subscriber user hiring staff members according to the needs of the shift schedule.

22. The method of claim 21 wherein the internet source is Google® Popular Times.

23. The method of claim 22 wherein the employer subscriber user hires one or more qualified individual employee subscriber users to staff shifts that represent peak business hours based on the assessment of the overlay of the schedule and the peak and non-peak business days and times.

24. The method of claim 23 wherein the employer subscriber user decreases staffing for shifts that represent non-peak business hours based on the assessment of the overlay of the schedule and the peak and non-peak business days and times.

25. A web and mobile-based implemented job placement recruitment system, social networking application (“app”), comprising;
a computer processor and database;
a scheduler of availability, the scheduler comprising time and days in which a qualified individual employee subscriber user is available and unavailable for accepting employment opportunities, wherein all employee subscriber user members create a scheduler of availability;
the database storing member profile information for a plurality of subscriber user members, each of the plurality of members establishing network connections with one another;
the computer processor identifying a plurality of employee subscriber users whom are seeking employment opportunities by means of a search engine,
the computer processor identifying a plurality of employer subscriber users whom are seeking to hire qualified employee subscriber users for available employment shift opportunities;
wherein the computer processor identifies a plurality of qualified employee subscriber users relative to one another based on particular skills, experience levels, experience hours, historical connection and availabilities for short or long term job placement and ranking the employee subscriber users;
wherein the scheduler of availability for the qualified individual employee subscriber user comprises the qualified individual employee subscriber user inputting the time and days into the scheduler on which the qualified individual employee subscriber is available and unavailable to accept employment opportunities, wherein the selected time and days comprise availability information, wherein the availability information is published on the web and mobile-based implemented job placement recruitment system, social networking application so that it is visible by the plurality of employer subscriber users whom access the search engine to conduct a search for individual qualified employee subscriber users to fill available employment opportunities on a temporary or permanent basis;
the availability information being generated based on information gathered by means of an internet source and geolocation;
the search comprising a results list, wherein an individual employer subscriber user hires the qualified employee subscriber user during an available period of time on the scheduler based on the qualified employee subscriber user's experience hours and historical connection, wherein the scheduler depublishes the availability information of the qualified individual employee subscriber user at the moment the individual employer subscriber user hires the qualified employee subscriber user.

26. The system, social networking application of claim 25 wherein the experience hours are generated when the system is activated and deactivated at the beginning of a work shift and at the end of the shift respectively.

27. The system, social networking application of claim 26 wherein the database stores the generated experience hours on the qualified individual employee subscriber user's member profile so that the experience hours are tallied for the qualified individual employee subscriber user and added to the qualified individual subscriber employee subscriber user's member profile so that it is viewable by prospective employer subscriber users.

28. The system, social networking application of claim 25 wherein the availability information comprises availability, unavailability, peak demand availability or reserved availability periods of time.

29. A web and mobile-based implemented job placement recruitment system, social networking application (“app”), comprising;
a computer processor and database;
a scheduler of availability, the scheduler comprising time and days in which an individual employee subscriber user is available and unavailable for accepting employment opportunities;
the database storing member profile information for a plurality of subscriber user members, each of the plurality of members establishing network connections with one another;
the computer processor identifying a plurality of qualified employee subscriber users whom are seeking employment opportunities,
a search engine;
wherein the computer processor identifies the plurality of qualified employee subscriber users relative to one another based on particular skills including, experience levels, experience hours, geographical proximity, historical connection and availabilities for short or long term job placement and ranking the employee subscriber users;
wherein the scheduler of availability for an individual employee subscriber user comprises the individual employee subscriber user inputting the time and days into the scheduler on which the individual employee subscriber is available and unavailable to accept employment opportunities, wherein the selected time and days comprise availability information, wherein the availability information is published on the web and mobile-based implemented job placement recruitment system, social networking application so that it is viewable by a plurality of employer subscriber users whom access the search engine to conduct a search for qualified individual employee subscriber users seeking to fill available employment shift opportunities on a temporary or permanent basis;
the search comprising a results list, wherein an individual employer subscriber user hires a qualified individual employee subscriber user during an available period of time on the scheduler based on the qualified individual employee subscriber user's experience hours, geographical proximity and historical connection to the individual employer subscriber user, wherein the scheduler depublishes the availability information corresponding to the individual employee subscriber user's at the moment the individual employer subscriber user hires the individual employee subscriber user.

30. The system, social networking application of claim 29 wherein the database stores the historical connection on the individual employee subscriber user's member profile so that the historical connection to the individual employer subscriber user is stored for the individual employee subscriber user's and added to the individual employee subscriber user's member profile so that it is viewable by prospective employer subscriber users.

31. A web and mobile-based implemented job placement recruitment system, social networking application (“app”) to optimize employer staffing comprising;
a computer processor wherein the computer processor accesses peak and non-peak business days and times from an internet source by means of geolocation;
displaying the peak and non-peak business days and times on a web and mobile-based implemented job placement recruitment system, social networking application (“app”) interface;
displaying a shift schedule prepared by the employer subscriber user on the web and mobile-based implemented job placement recruitment system, social networking application (“app”) interface;
graphically overlaying the peak and non-peak business days and times onto the shift schedule so that the employer subscriber user can view the two data points simultaneously on the interface;
wherein the employee subscriber user assesses its staffing needs based on the graphical overlay and determines if staffing is sufficient.

32. The system, social networking application of claim 31 wherein the internet source is Google® Popular Times.

33. The system, social networking application of claim 32 wherein the employer subscriber user hires one or more qualified individual employee subscriber users to staff shifts that represent peak business hours based on the assessment of the overlay of the schedule and the peak and non-peak business days and times.

34. The system, social networking application of claim 33 wherein the employer subscriber user decreases staffing for shifts that represent non-peak business hours based on the assessment of the overlay of the schedule and the peak and non-peak business days and times.
